(19) United States
(12) Patent Application Publication
(10) Pub. No.: US 2006/0122870 A1
(43) Pub. Date: Jun. 8, 2006

(54) Techniques for accessing healthcare records and processing healthcare transactions via a network

(75) Inventors: Gary M. Austin, Marietta, GA (US); Gerard Patrick White, Marietta, GA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Clearwave Corporation, Marietta, GA (US)

(21) Appl. No.: 11/292,113

(22) Filed: Dec. 2, 2005

Related U.S. Application Data
(60) Provisional application No. 60/632,336, filed on Dec. 2, 2004.

(51) Int. Cl. G06F 19/00

(52) U.S. Cl. 705/3; 705/4; 707/9

(57) ABSTRACT

A technique for automating the check-in and check-out process within the healthcare industry and enabling the portability of personal health records. In one particular exemplary embodiment, the technique may be realized as a method including receiving identification information and other information, retrieving at least one of personal information or insurance information using the identification, processing a heath related transaction using at least one of personal information or insurance information, and outputting information associated with a processed health related transaction.

### CROSS-REFERENCE TO RELATED APPLICATIONS

This patent application claims priority to U.S. Provisional Patent Application No. 60/632,336, filed Dec. 2, 2004, which is hereby incorporated by reference herein in its entirety.

### FIELD OF THE DISCLOSURE

The present disclosure relates generally to automatically processing a healthcare transaction and, more particularly, to techniques for accessing healthcare records and processing healthcare transactions via a network.

### BACKGROUND OF THE DISCLOSURE

The healthcare industry in the United States accounted for nearly $2.3 trillion in transactions in 2003 and is growing at the rate of 13% annually. Healthcare administration costs are estimated to be 15%, or $350 billion annually. Further, the electronic payment industry represents nearly $2 trillion annually and is growing at a rate of 17% annually.

Based on these statistics, the healthcare and electronic payment industries are two of the largest markets in the world. However, the healthcare industry remains a bastion of paper-Insurance Portability and Accountability Act (“HIPAA”) helped established standards around healthcare Electronic Data Interchange (EDI) transactions, security and privacy of personal health information to allow the industry to begin the transition from paper based health records and healthcare transaction to a real-time basis. Hospitals, physicians and other healthcare providers are slowly adopting electronic medical record systems and individuals are only beginning to think about personal health records.

Fundamentally no solutions begin the healthcare encounter electronically and have sufficient data to complete the healthcare transaction upon check-out. A first time patient arrives at an office and is handed a clipboard and asked to complete the two to three page document. The patient enters in their demographic and health insurance information plus any know allegories and medications. The patient consent is also typically included within this package of information. The completed registration information and consent form is returned to front office staff with the patient's insurance card.

The front office staff then enters the clipboard information into a practice management system and makes a copy of the insurance card. The staff then proceeds to check the person's eligibility by logging into the payor's website or person's eligibility by logging into the payor's website or calling the payor directly to determine the patient does have insurance plus a copay and a deductible. The staff then proceeds to type all of this information into a practice management system and at this point we have the information in an electronic form. This process takes 20 to 30 minutes to complete, is prone to errors and must be repeated time and time again as the patient makes their way through the healthcare system.

Until the check-in process is changed to, the industry will continue to be saddled with high administrative costs, errors, fraud and abuse.

When a patient checks out of a provider's office, they typically pay only the co-pay amount that is printed on their insurance card. The current batch process does not allow for the provider to know what the patient responsibility is at the point of care. The failure to process insurance claims real-time results in the slow, expensive, and labor-intensive processing of insurance claims.

### SUMMARY OF THE DISCLOSURE

Techniques for accessing healthcare records and processing healthcare transactions via a network are disclosed. In one exemplary embodiment, the techniques may be realized as a system including a data store to store information associated with a person, the information including an identification information, an input to receive the identification information and other information, a processor coupled to the input and the data store to process an insurance claim using the identification information and the other information, and an output coupled to the processor and the data store to output information associated with the processed insurance claim.

In accordance with another exemplary embodiment, a method may include receiving identification information and other information, retrieving at least one of personal information or insurance information using the identification, processing an insurance claim using the at least one of personal information or insurance information, and outputting information associated with a processed insurance claim.

In accordance with yet another exemplary embodiment, a method may include receiving identification information associated with a person, receiving identification information associated with a Point of Sale (PoS) device, and providing access to information based on the identification information associated with a person and identification information associated with a Point of Sale (PoS) device.

In accordance with still another exemplary embodiment, a system may include a data store to store identification information associated with a person and identification information associated with a Point of Sale (PoS) device, an input to receive information from a PoS device, and a processor coupled to the input and the data store to authenticate the identity of a person using the stored identification information associated with a person and the stored identification information associated with a PoS device.

In accordance with yet a further exemplary embodiment, a computer-accessible medium may be encoded with computer program code effective to receive identification information and other information, retrieve at least one of personal information or insurance information using the identification, process an insurance claim using the at least one of personal information or insurance information, and output information associated with a processed insurance claim.

In accordance with still a further exemplary embodiment, a computer-accessible medium may be encoded with computer program code effective to receive identification information associated with a person, receive identification information associated with a Point of Sale (PoS) device, and provide access to information based on the identification information associated with a person and identification information associated with a Point of Sale (PoS) device.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 depicts an exemplary embodiment of a system for automatically processing an insurance claim in accordance with an exemplary embodiment of the present disclosure;

FIG. 2 depicts an exemplary embodiment of a database management system according to an embodiment of the present disclosure.

FIG. 3 depicts an exemplary embodiment of a point of service(PoS) module according to an embodiment of the present disclosure.

FIG. 4 depicts an exemplary embodiment of a sponsor module according to an embodiment of the present disclosure.

FIG. 5 depicts an exemplary embodiment of a member module according to an embodiment of the present disclosure.

FIG. 6 depicts an exemplary embodiment of a manager module according to an embodiment of the present disclosure.

FIG. 7 depicts an exemplary embodiment of a financial services module according to an embodiment of the present disclosure.

FIG. 8 depicts a flowchart which illustrates an exemplary method for member check-in at a point of service according to an embodiment of the present disclosure.

FIG. 9 depicts a flowchart which illustrates an exemplary method for member check-out at a point of service according to an embodiment of the present disclosure.

FIG. 10 depicts a flowchart which illustrates an exemplary method for automatic and/or electronic processing of an insurance claim according to an embodiment of the present disclosure.

FIG. 11 depicts a flowchart which illustrates an exemplary method for enrolling into a system for automatic and/or electronic processing of an insurance claim according to an embodiment of the present disclosure.

FIG. 12 depicts an exemplary embodiment of a system for automatically processing an insurance claim according to an embodiment of the present disclosure.

FIG. 13 depicts an exemplary embodiment of a method for accessing data according to an embodiment of the present disclosure.

FIG. 14 depicts an exemplary embodiment of a screen display according to the present disclosure.

FIG. 15 depicts an exemplary embodiment of a screen display according to the present disclosure.

FIG. 16 depicts an exemplary embodiment of a screen display according to the present disclosure.

FIG. 17 depicts an exemplary embodiment of a screen display according to the present disclosure.

FIG. 18 depicts an exemplary embodiment of a screen display according to the present disclosure.

FIG. 19 depicts an exemplary embodiment of a screen display according to the present disclosure.

FIG. 20 depicts an exemplary embodiment of a screen display according to the present disclosure.

FIG. 21 depicts an exemplary embodiment of a screen display according to the present disclosure.

FIG. 22 depicts an exemplary embodiment of a screen display according to the present disclosure.

FIG. 23 depicts an exemplary embodiment of a screen display according to the present disclosure.

FIG. 24 depicts an exemplary embodiment of a screen display according to the present disclosure.

FIG. 25 depicts an exemplary embodiment of a screen display according to the present disclosure.

FIG. 26 depicts an exemplary embodiment of a screen display according to the present disclosure.

FIG. 27 depicts an exemplary embodiment of a screen display according to the present disclosure.

FIG. 28 depicts an exemplary embodiment of a screen display according to the present disclosure.

FIG. 29 depicts an exemplary embodiment of a screen display according to the present disclosure.

FIG. 30 depicts an exemplary embodiment of a screen display according to the present disclosure.

FIG. 31 depicts an exemplary embodiment of a screen display according to the present disclosure.

FIG. 32 depicts an exemplary embodiment of a screen display according to the present disclosure.

### DETAILED DESCRIPTION OF EXEMPLARY EMBODIMENTS

Exemplary embodiments of the present disclosure are discussed in detail below. While specific exemplary embodiments are discussed, it should be understood that this is done for illustration purposes only. A person skilled in the relevant art will recognize that other components and configuration can be used without parting from the spirit and scope of the present disclosure.

Overview

Exemplary embodiments of the present disclosure may provide techniques for the secure, efficient, and automatic accessing and processing healthcare records, including processing of an insurance transaction. As described herein, the processing of an insurance transaction may include, without limitation, any benefit verification and/or payment processing associated with an insurance claim. For example, the processing of an insurance transaction may include the verification of insurance coverage (for example, a person is enrolled in a benefits program and the person is authorized to receive benefits from an insurance carrier as provided by the benefits program) and payment processing (for example, collecting payment from various financial accounts, such as, for example, the financial accounts associated with the insurance carrier and/or the person). Additionally, processing a health-related transaction may include accessing data, providing access to data, or storing data that is related.

Exemplary embodiments of the present disclosure may provide software applications that may interface with, for example, a real-time, network-based information repository (for example, databases) for processing a health-related transaction. In such an exemplary embodiment, systems and methods therein may enable, for example: enrollment into a benefits program; secure, automatic, and electronic patient check-in at, for example, a physician's office, hospital, or pharmacy; secure patient check out at, for example, a physician's office, hospital, or pharmacy, including providing multiple payment options for the patient, such as, for example, paying with a credit card or debit card and distributing from a pre-tax medical account; automatic and electronic processing of an insurance claim, including collecting payment from any and all sources owing money (for example, the insurance carrier and/or the patient); and secure online access to information for a patient, program provider (for example, employer), insurance carrier, physician, and/or pharmacy.

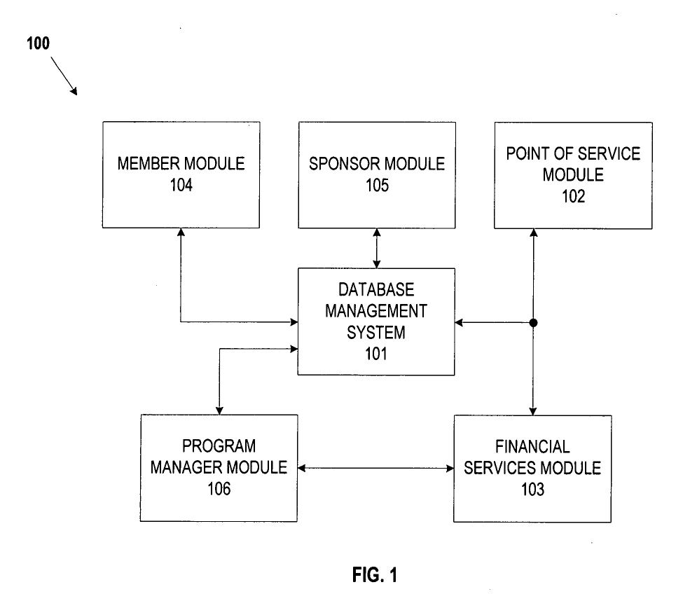

Referring to FIG. 1, there is shown an exemplary embodiment of a system 100 for automatically and/or electronically processing a health-related transaction. System 100 may include a database management system 101, a point-of-service (PoS) module 102, a financial services module 103, a member module 104, a sponsor module 105, and a manager module 106. As is shown in FIG. 1, each of the point-of-service (PoS) module 102, financial services module 103, member module 104, sponsor module 105, and manager module 106 may be coupled to database management system 101. Additionally, financial services module 103 may be coupled to PoS module 102 and program manager module 106.

In an exemplary embodiment of the present disclosure, each of the components of system 100 may be components of a computer network and may be coupled to each other via any one of a number of network connections, including, but not limited to, an intranet connection, a Local Area Network (LAN) connection, a Wide Area Network (WAN) Connection, the Internet (for example, World Wide Web), a wireless network, a Bluetooth connection, and the like. Further, although the exemplary system shown in FIG. 1 includes a number of individual modules, other exemplary systems may include any combination of only some of the modules shown in FIG. 1.

Database Management System

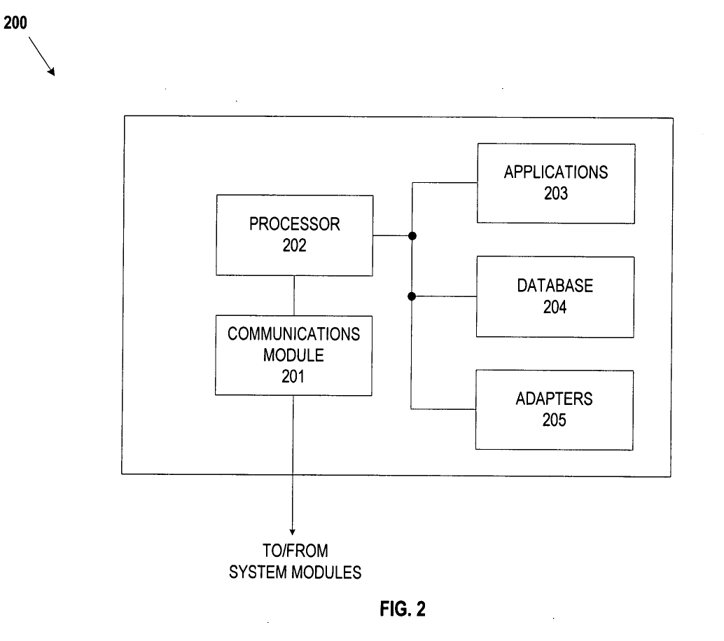

FIG. 2 depicts an exemplary embodiment of a database management system 200 according to an embodiment of the present disclosure. Database management system 200 may include, for example, communications module 201, a processor 202, applications 203, database 204, and adapters module 205.

In an exemplary embodiment of the disclosure, database management system 200 may be a component in a system for automatically and/or electronically processing a health-related transaction, such as, for example, the system shown in FIG. 1. In such an embodiment, database management system 200 may be coupled to other system components (not shown in FIG. 2) via communications module 201. For example, communications module 201 may include hardware and/or software components for enabling network communications via, for example, a wide area network (WAN), a local area network (LAN), a global network such as the Internet, a telephone network such as a public switch telephone network, a wireless communication network, a cellular network, an intranet, or the like, or any combination thereof.

Further, database management system 200 may be a single computer or comprised of a plurality of computers and data storage devices coupled together for the purpose of storing, modifying, processing, and/or extracting information from database 204.

In an exemplary embodiment of the disclosure, database management system 200 may be a real-time, network-based information database or plurality of databases that enable the electronic and automatic processing of a health-related transaction. In such an embodiment, database 204 may store information about members, (i.e., benefits recipients, patients, or the like), a program, financial services, regulatory constraints, and other information related to members and/or sponsors, for example.

In an exemplary embodiment of the disclosure, information about the members may include, for example, personal information, such as name, address, phone number, medical history, insurance coverage, financial information, member history, member rewards associated with a rewards program for, for example, rewarding behavior that may produce healthier lifestyle. In such an embodiment, information about the member may also include a unique identifier that may or may not be known to the member. This unique identifier may be used by a system for automatically and/or electronically processing a health-related transaction to enable secure access to information, for example.

In an exemplary embodiment of the present disclosure, information about the benefits program may include, for example, information about a benefits program, including, for example, constraints associated with insurance coverage, program history, program reporting, and program membership.

In an exemplary embodiment of the present disclosure, information about financial services may include, for example, member account information to provide payment, provider account information, any financial information to process a transaction and/or claim, and/or the like.

In an exemplary embodiment of the present disclosure, information about regulatory constraints may include, for example, information associated with Health Insurance Portability and Accountability Act (HIPAA) policies and/or any other regulatory policies/constraints including, without limitation, for example, regulatory restrictions regarding access to health-related information.

In an exemplary embodiment of the present disclosure, other information related to members and/or sponsors may include, for example, information about building access, parking access, security clearances, and/or the like. In such an embodiment, members may carry a multi-function identification device that may provide building access, parking access, access to secure areas and/or documents, which may also serve as an identification device for automatically and/or electronically processing a health-related transaction.

As noted above, database management system 200 may also include an applications module 203. Applications module 203 may utilize, for example, industry standard Web and Web service technologies to provide software applications and user interfaces, for example, to manage the database 204 and other modules and/or components in a system for automatically and/or electronically processing a health-related transaction, such as, for example, the system shown in FIG. 1.

In an exemplary embodiment of the present disclosure, such software applications may include, for example, without limitation: scalable network solutions to provide an infrastructure for supporting a plurality of users while at the same time ensuring the security and tracking of all transactions; distributed services oriented software solutions for enabling users of the exemplary system to access information from anywhere; and/or Web-services that allow for robust and secure data sharing and inoperability.

As noted above, in an exemplary embodiment of the present disclosure, database management system 200 may also include an adapters module 205. Adapters module 205 may provide software adapters that may provide, for example, customized software solutions for enabling direct interfacing with components/modules in the exemplary system, including without limitation, direct interfacing with financial networks and institutions, program managers, sponsors, and other like service providers.

In yet a further exemplary embodiment of the present disclosure, exemplary adapters provided by adapters module 205 may include, for example, integration adapters that may provide components/modules in an exemplary system that do not have infrastructure to support, for example, real-time direct interfacing with database management system 200.

Point of Service (PoS) Module

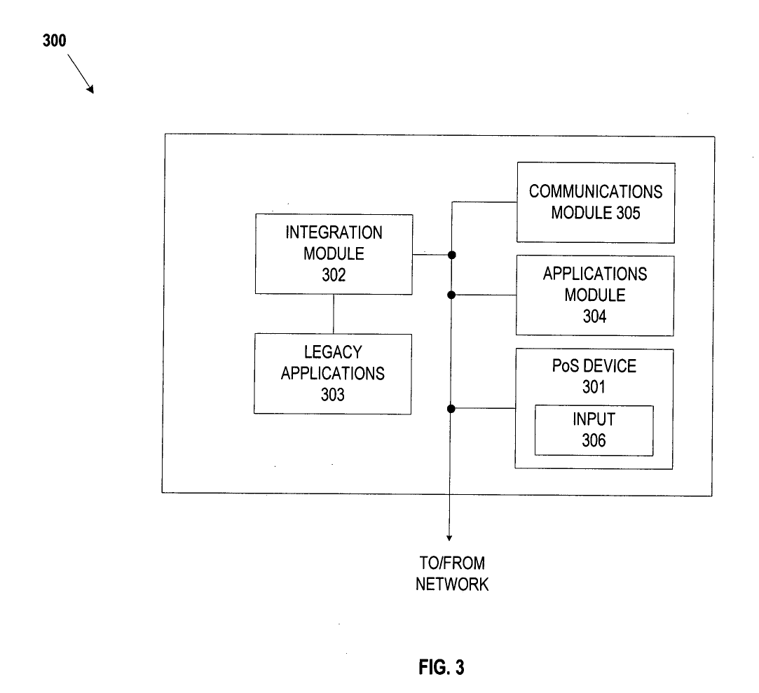

FIG. 3 depicts an exemplary embodiment of a point of service(PoS) module 300 according to an embodiment of the present disclosure. As is shown in FIG. 3, PoS module 300 may include a Pos Device 301, an integration module 302, a legacy applications module 303, an applications module 304, and a communications module 305.

In an exemplary embodiment of the present disclosure, PoS module 300 may be a component in a system for automatically and/or electronically processing a health-related transaction, such as, for example, the system shown in FIG. 1. In such an embodiment, PoS module 300 may be coupled to other system components, such as, for example, a database management system (not shown in FIG. 3) via communications module 305. Accordingly, a Media Access Control (MAC) address may be associated with the PoS device to uniquely identify the PoS device in a network, for example.

For example, in an exemplary embodiment of the present disclosure, PoS module 300 may be coupled to a database management system to enable, for example, program marketing, provider and/or member enrollment, membership administration, member identification, member eligibility inquiries, service notification, payment authorization, and the like.

PoS device 301 may be any device that provides members, for example, a benefits recipient, such as a patient, with a secure user interface or the like that enables, for example, identification, gathering of program specific information, payment for services, and the like. In exemplary embodiments of the present disclosure, PoS device 301 may include, but is not limited to: any computer device or communications device including, for example, a personal computer (PC), a workstation, a mobile device, a phone, a handheld PC, a personal digital assistant (PDA), a thin client, a fat client, a network appliance, an Internet browser, a paging device, an alert device, a television, an interactive television, a receiver, a tuner, a high definition (HD) television, an HD receiver, a video-on-demand (VOD) system, a server, or other device.

As is shown in FIG. 3, in an exemplary embodiment of the present disclosure, an input 306 may be coupled to PoS device 301. In an exemplary embodiment of the present disclosure, input 306 may be a Radio-Frequency Identification (RFID) tag reader. In such an embodiment, the RFID tag reader may include an RFID transceiver (not shown) to supply RF queries to active and/or passive RFID tags (not shown) such as, for example, low-frequency tags (for example, 125 or 134.2 kHz), high-frequency tags (13.56 MHz), UHF tags (868 to 956 MHz), and microwave tags (2.45 GHz). In an exemplary embodiment of the present disclosure, the RFID tag reader may receive a RF signal from a RFID tag, process the RF signal, and use the processed signal to identify the member and automatically retrieve member information to be delivered to PoS module 300, for example.

In a further exemplary embodiment of the present disclosure, input 306 may be a magnetic strip reader for reading the magnetic strip of a card containing a magnetic strip, for example. The magnetic strip may contain information to identify the member and this information may be used to automatically retrieve member information to be delivered to PoS module 300, for example.

In yet a further exemplary embodiment of the present disclosure, input 306 may be a keypad or touch screen containing a keypad or the like. In such an embodiment, a member may use the keypad or like device to input information to identify the member. This information may then be used to automatically retrieve member information to be delivered to PoS module 300, for example.

In still further exemplary embodiments of the present disclosure, input 301 may be any device capable of receiving information to identify a member, for example. Such devices may include, without limitation, a bar code scanner and biometric identification devices such as retina scanners, thumbprint scanners, voice print scanners, face-recognition devices, and the like.

As noted above, in an exemplary embodiment of the present disclosure, PoS module 300 may include an integration module 302 and a legacy application module 303 coupled to the integration module 302. In such an embodiment, integration module may comprise any computer device, communications device, or any combination of such devices that, for example, provide seamless integration with legacy applications that may be included in legacy application module 303. Further, integration module 302 may include applications for enabling a single place for users within PoS module 300, for example, to sign onto the PoS module 300 for access to shared data within PoS module 300. Further, integration module 302 may include applications or the like to automate workflow across legacy applications 303.

For example, in a doctor's office, hospital, patient care facility, or the like, patient records may be stored on an existing storage system while image data, such as radiological images, may be stored on a different storage system. In an exemplary embodiment of the present disclosure, legacy applications may provide access to such records. Integration module 302 may provide a single system (comprised of one or a plurality of devices) for accessing, processing, and/or modifying the patient records as well as the image data. Further, integration module 302 may enable other components of a system for automatically processing a health-related transaction, for example, to utilize this information.

As noted above, in an exemplary embodiment of the present disclosure, PoS module 300 may also include an applications module 304. In such an embodiment, applications module 304 may utilize, for example, industry standard Web and Web service technologies to provide software applications and user interfaces, for example, to manage PoS module 300 and/or other components in a system for automatically and/or electronically processing a health-related transaction, such as, for example, the system shown in FIG. 1.

In an exemplary embodiment of the present disclosure, as is discussed above with respect to FIG. 2, such software applications may include, for example, without limitation: scalable network solutions to provide an infrastructure for supporting a plurality of users while at the same time ensuring the security and tracking of all transactions; distributed services oriented software solutions for enabling users of the exemplary system to access information from anywhere; and/or Web-services that allow for robust and secure data sharing and inoperability.

Further, as noted above, in an exemplary embodiment of the present disclosure, PoS module 300 may include a communication module 305. In an exemplary embodiment of the present disclosure, communication module 305 may couple PoS module 300 to other components in a system for automatically and/or electronically processing a health-related transaction. In such an embodiment, communications module 305 may include hardware and/or software components for enabling network communications via, for example, a wide area network (WAN), a local area network (LAN), a global network such as the Internet, a telephone network such as a public switch telephone network, a wireless communication network, a cellular network, an intranet, and/or the like, or any combination thereof.

In an exemplary embodiment of the present disclosure, communication module 305 may transmit, for example, identification information about a member and the MAC address to authenticate the identity of the member. In such an embodiment, the combination of the identification information and the MAC address, for example, may provide secure, HIPAA compliant access to data and/or information about the member. Also, this combination of information may be combined with additional information, such as, for example, a unique identifier associated with the service provider/administrator to provide further layers of security.

Sponsor Module

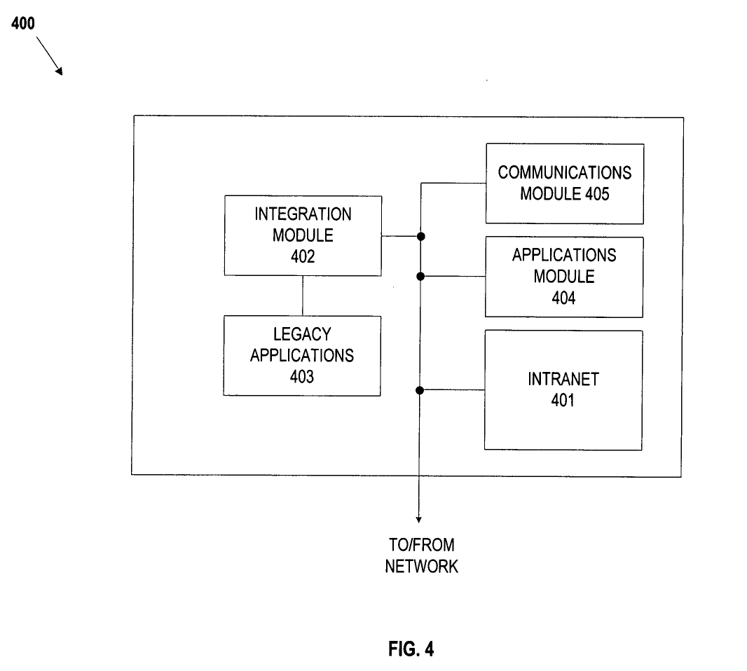

FIG. 4 depicts an exemplary embodiment of a sponsor module 400 according to an embodiment of the present disclosure. As is shown in FIG. 4, in an exemplary embodiment of the present disclosure, sponsor module 400 may include, for example, an intranet 401, an integration module 402 coupled to legacy applications 403, an applications module 404, and a communications module 405.

As referred to herein, a sponsor may administer, for example, a group-based program, such as a group-based insurance program or the like. In exemplary embodiments of the present disclosure, sponsors may include, for example, employers, labor unions, societies, and the like.

In an exemplary embodiment of the present disclosure, sponsor module 400 may be a component in a system for automatically and/or electronically processing a health-related transaction, such as, for example, the system shown in FIG. 1. In such an embodiment, sponsor module 400 may be coupled to other system components, such as, for example, a database management system (not shown in FIG. 4) via communications module 405.

For example, in an exemplary embodiment of the present disclosure, sponsor module 400 may be coupled to a database management system to enable, for example, program marketing, member and/or sponsor enrollment, membership administration, payment authorization, and the like.

As noted above, in an exemplary embodiment of the present disclosure, sponsor module 400 may include intranet 401. In such an embodiment, intranet 401 may enable, for example, members of a group-based program to manage respective individual accounts within the program via, for example, a secure network. For example, in a group-based insurance program, intranet 401 may enable a member to access his or her account, provide, modify, and/or update personal information, and manage insurance claims, including with limitation, electronically and automatically submitting insurance claims, providing payment, and/or providing information for processing insurance claims.

Intranet 401 may include one or a plurality of devices coupled to a network (not shown) for secure communication of information between, for example, any hardware and/or software components that may enable network communications.

As noted above, in an exemplary embodiment of the present disclosure, sponsor module 400 may include an integration module 402 and a legacy application module 403 coupled to the integration module 402. In such an embodiment, integration module may comprise any computer device, communications device, or any combination of such devices that, for example, provide seamless integration with legacy applications that may be included in legacy application module 403. Further, integration module 402 may include applications for enabling a single place for users within sponsor module 400, for example, to sign onto the sponsor module 400 for access to shared data within sponsor module 400. Further, integration module 402 may include applications or the like to automate workflow across legacy applications 403.

For example, within a sponsor's organization or the like, member accounts including, for example, personal information and employment status may be stored on an existing storage system while insurance claim and other program information may be stored on a different storage system. In an exemplary embodiment of the present disclosure, legacy applications may provide access to such accounts and information. Integration module 402 may provide a single system (comprised of one or a plurality of devices) for accessing, processing, and/or modifying the accounts as well as the insurance claim and other program information. Further, integration module 402 may enable other components of a system for automatically processing a health-related transaction, for example, to utilize this information.

As noted above, in an exemplary embodiment of the present disclosure, sponsor module 400 may also include an applications module 404. In such an embodiment, applications module 404 may be similar to those described above with respect to FIGS. 2 and 3.

Further, as noted above, in an exemplary embodiment of the present disclosure, sponsor module 400 may include a communication module 405. In an exemplary embodiment of the present disclosure, communication module 405, may for example, couple sponsor module 400 to other components in a system for automatically and/or electronically processing a health-related transaction. In such an embodiment, communications module 405 may be similar to those described above with respect to FIGS. 2 and 3.

In a further embodiment of the present disclosure, communication module 405 may enable communication between, for example, components of intranet 401 and between intranet 401 and other components in a system for automatically and/or electronically processing a health-related transaction.

Member Module

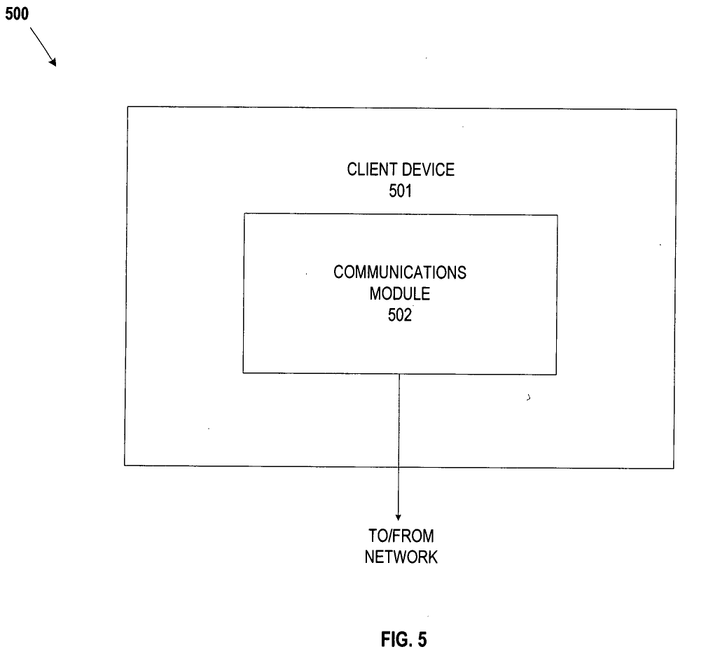

FIG. 5 depicts an exemplary embodiment of a member module 500 according to an embodiment of the present disclosure. As is shown in FIG. 5, in an exemplary embodiment of the present disclosure, sponsor module 500 may include, for example, a client device 501. In such an embodiment, client device 501 may include a communications module 502.

As referred to herein, a member may be, for example, the primary participants in a system for automatically and/or electronically processing a health-related transaction. As such, members may include without limitation, benefits recipients, claimants, the insured, patients, and the like. In exemplary embodiments of the present disclosure, members may participate in programs, such as insurance programs, individually or as part of a group-based sponsored program.

In an exemplary embodiment of the present disclosure, member module 500 may be a component in a system for automatically and/or electronically processing a health-related transaction, such as, for example, the system shown in FIG. 1. In such an embodiment, member module 500 may be coupled to other system components, such as, for example, a database management system (not shown in FIG. 5) via communications module 502.

For example, in an exemplary embodiment of the disclosure, member module 500 may be coupled to a database management system to enable, for example, program marketing, member enrollment, membership administration, payment authorization, and the like.

As noted above, member module 500 may include a client device 501. In an exemplary embodiment of the present disclosure, the client device 501 may include, but is not limited to: any computer device or communications device including, for example, a personal computer (PC), a workstation, a mobile device, a phone, a handheld PC, a personal digital assistant (PDA), a thin client, a fat client, an network appliance, an Internet browser, a paging device, an alert device, a television, an interactive television, a receiver, a tuner, a high definition (HD) television, an HD receiver, a video-on-demand (VOD) system, a server, or other device.

In such an embodiment, the communications module 502 may enable communication between member module 500 and other components in a system for automatically and/or electronically processing a health-related transaction. Communications module 502 may include hardware and/or software components for enabling network communications via, for example, a wide area network (WAN), a local area network (LAN), a global network such as the Internet, a telephone network such as a public switched telephone network, a wireless communication network, a cellular network, an intranet, and/or the like, or any combination thereof.

In an exemplary embodiment of the present disclosure, client device 501 of member module 500 may enable a member to, for example, enroll in a program and manage their account remotely. Accordingly, client device 501 and communication device 502, alone or in combination, may include a software application, such as, for example, a web browser or like application that enables, for example, web-based enrollment and web-based participation within the program.

Manager Module

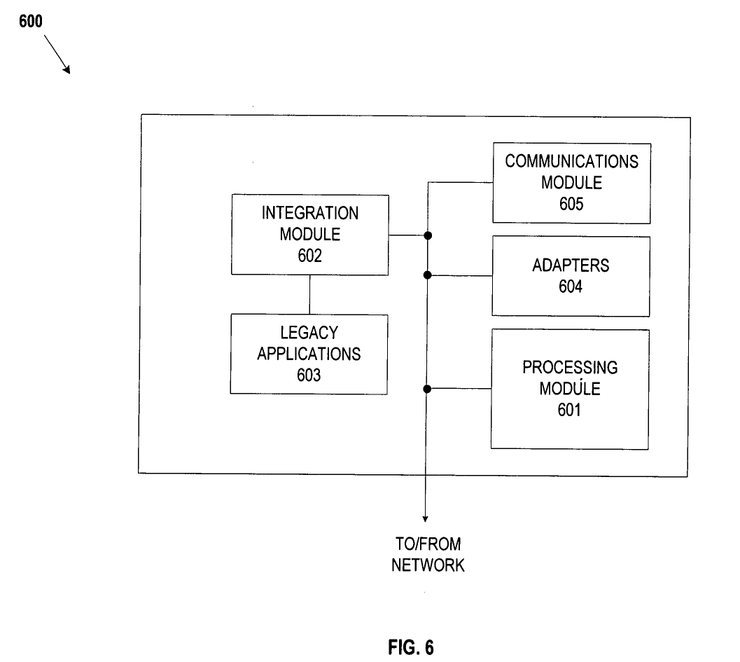

FIG. 6 depicts an exemplary embodiment of a program manager module 600 according to an embodiment of the present disclosure. As shown in FIG. 6, in an exemplary embodiment of the present disclosure, sponsor module 600 may include, for example, a processing module 601, an integration module 602 coupled to legacy applications module 603, adapters module 604, and a communications module 605.

As referred to herein, a manager may include any person or plurality of people such as an organization that may manage programs to provide, for example, insurance coverage, health benefits, or the like, may deliver program benefits to members, and may automatically and/or electronically process insurance claims associated with such programs. In an exemplary embodiment of the present disclosure, managers may include, for example, an insurance company, a benefits provider, information services provider, financial services provider or the like.

In an exemplary embodiment of the present disclosure, manager module 600 may be a component in a system for automatically and/or electronically processing a health-related transaction, such as, for example, the system shown in FIG. 1. In such an embodiment, manager module 600 may be coupled to other system components, such as, for example, a database management system (not shown in FIG. 6) via communications module 605.

For example, in an exemplary embodiment of the present disclosure, manager module 600 may be coupled to a database management system to enable, for example, program marketing, program, sponsor and/or provider enrollment, membership administration, payment authorization, member eligibility inquiries, service notifications, payment notifications, and the like.

In an exemplary embodiment of the present disclosure, processing module 601 may include hardware and/or software to automatically and/or electronically process a health-related transaction. In such an embodiment, processing module 601 may, for example, determine member eligibility, determine member benefits, and process a claim, including processing payment of the claim.

As noted above, in an exemplary embodiment of the present disclosure, sponsor module 600 may include an integration module 602 and a legacy application module 603 coupled to the integration module 602. In such an embodiment, integration module may comprise any computer device, communications device, or any combination of such devices that, for example, provide seamless integration with legacy applications that may be included in legacy application module 603. Further, integration module 602 may include applications for enabling a single place for users within manager module 600, for example, to sign onto the manager module 600 for access to shared data within manager module 600. Further, integration module 602 may include applications or the like to automate workflow across legacy applications 603.

For example, within a manager's organization or the like, program information including, for example, information associated with member insurance coverage (for example, constraints on coverage) may be stored on an existing storage system while payment information may be stored on a different storage system. In an exemplary embodiment of the present disclosure, legacy applications may provide access to such program and payment information. Integration module 602 may provide a single system (comprised of one or a plurality of devices) for accessing, processing, and/or modifying the program information as well as payment information. Further, integration module 602 may enable other components of a system for automatically processing a health-related transaction, for example, to utilize this information.

As noted above, in an exemplary embodiment of the present disclosure, adapters module 604 may provide software adapters that may provide, for example, customized software solutions for enabling direct interfacing with components/modules in the exemplary system, including without limitation, direct interfacing with financial networks and institutions, sponsors, and other like service providers. Adapters module 604 may also include, for example, integration adapters that may provide components/modules in an exemplary system that do not have infrastructure to support, for example, real-time direct interfacing with a financial network or database management system, for example.

Communications module 605 may enable communication between manager module 600 and other components, such as, for example, financial networks and institutions in a system for automatically and/or electronically processing a health-related transaction. In an exemplary embodiment of the present disclosure, communications module 605 may include hardware and/or software components for enabling network communications via, for example, a wide area network (WAN), a local area network (LAN), a global network such as the Internet, a telephone network such as a public switch telephone network, a wireless communication network, a cellular network, an intranet, and/or the like, or any combination thereof. In an alternative exemplary embodiment of the present disclosure, communications module 605 may enable a direct, secure connection with a financial institution and/or database management system, for example.

Financial Services Module

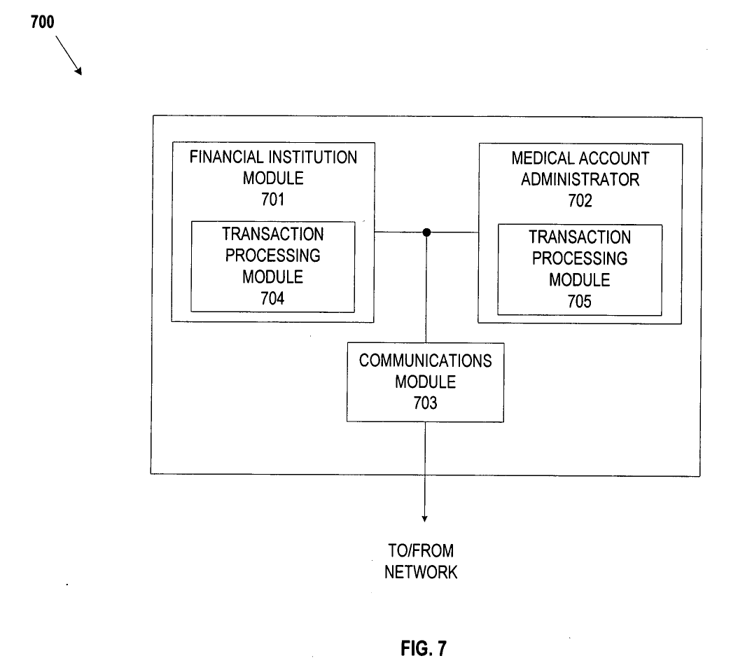

FIG. 7 depicts an exemplary embodiment of a financial services module 700 according to an embodiment of the present disclosure. As is shown in FIG. 7, in an exemplary present embodiment of the disclosure, financial services module 700 may include, for example, a financial institution module 701, a medical account administrator 702, and a communications module 703.

As referred to herein, a financial institution, financial services institution or financial services network may include any person or plurality of people such as an organization that may provide financial services for, for example, processing a health-related transaction. In an exemplary embodiment of the present disclosure, a financial institution, financial services institution or financial services network may include, for example, banks, credit unions, or the like.

In an exemplary embodiment of the present disclosure, financial services module 700 may be a component in a system for automatically and/or electronically processing a health-related transaction, such as, for example, the system shown in FIG. 1. In such an embodiment, financial services module 700 may be coupled to other system components, such as, for example, a database management system (not shown in FIG. 7), a program manager (not shown in FIG. 7), and/or a network via communications module 703.

For example, in an exemplary embodiment of the present disclosure, financial services module 700 may be coupled to a database management system and/or a program manager module and/or a network to enable, for example, payment authorization, payment, and the like.

As noted above, in an exemplary embodiment of the present disclosure, financial services module 700 may include a financial institution module 701. Financial institution module 701 may include a transaction processing module 704 that may process financial transactions related to insurance claims, for example. In an exemplary embodiment of the present disclosure, transaction processing module 704 may receive information about the amounts owed by various parties associated with, for example, a health-related transaction and automatically credit and/or debit, for example, accounts of those parties, depending upon the information received.

As noted above, financial services module 700 may also include a medical account administrator 702. In an exemplary embodiment of the present disclosure, medical account administrator 702 may manage, for example, pre-tax medical accounts that enable members to withhold pre-tax dollars via, for example, a payroll deduction, in an account for medical expenses and draw from the account to pay for such expenses. In such an embodiment, medical account administrator 702 may include a transaction processing module 705 that may process transactions related to drawing from the medical account. In an exemplary embodiment of the present disclosure, transaction processing module 705 may receive information about a draw on an account and process the transaction, depending upon the information received.

As noted above, financial services module 700 may further include a communications module 703. In an exemplary embodiment of the present disclosure, communications module 703 may enable communication between, for example, financial services module 700 and other components in a system for automatically and/or electronically processing a health-related transaction. In another exemplary embodiment of the present disclosure, communications module 703 may include hardware and/or software components for enabling network communications via, for example, a wide area network (WAN), a local area network (LAN), a global network such as the Internet, a telephone network such as a public switch telephone network, a wireless communication network, a cellular network, an intranet, and/or the like, or any combination thereof. In an alternative exemplary embodiment of the present disclosure, as is shown in FIG. 7, communications module 703 may also enable communication between financial institution module 701 and medical account administrator 702, for example.

Exemplary Methods

Exemplary embodiments of the present disclosure may provide exemplary methods for automatically and/or processing a health-related transaction.

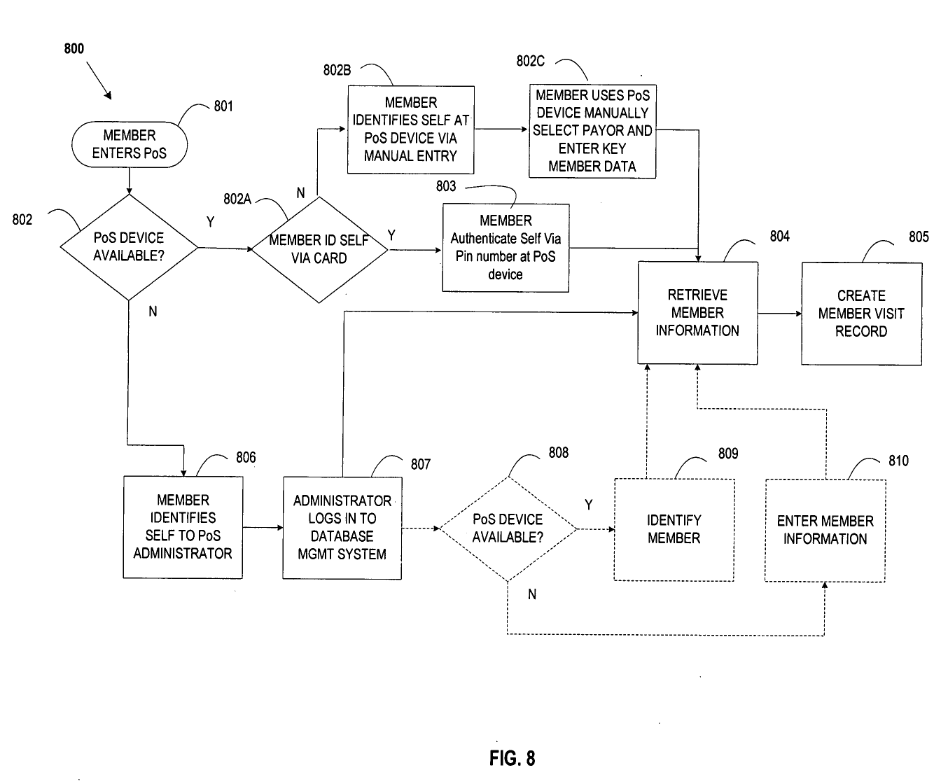

FIG. 8 depicts a flowchart 800 which illustrates an exemplary method for member check-in at a point of service (PoS) in accordance with an embodiment of the present disclosure.

In block 801, a member may enter a PoS. In an exemplary embodiment of the present disclosure, a PoS may include, for example, a doctor's office, a hospital, a pharmacy, or any other like service provider.

In block 802, a member may determine whether a PoS device is available at the PoS. In an exemplary embodiment of the present disclosure, a member may look for, for example, a kiosk, computer, or like device. In such an embodiment, a kiosk, computer, or like device may be available in, for example, a reception area in a doctor's office, any room of a hospital, or a prescription drop-off area of a pharmacy. If a PoS is available, flowchart 803 may proceed to block 802A. If a PoS device is not available, flowchart 800 may proceed to block 806.

In block 802A, it may be determined whether a member has identified himself or herself via a card, for example. In an exemplary embodiment of the present disclosure, a member may identify himself or herself using an RFID card or the like. If a member identifies himself or herself using a card, flowchart 800 may proceed to block 802B. If a member does not identify himself or herself using a card, flowchart 800 may proceed to block 803.

In block 802B, a member may identify himself or herself at a PoS device via manual entry, for example.

In block 802C, a member may use a PoS device to select a payor and key in member data, for example. In an exemplary embodiment of the present disclosure, member data may include, for example, a social security, a date of birth, a gender, a first name, a surname, a member number, a group number, and/or the like.

In block 803, a member may authenticate himself or herself at the PoS device. In an exemplary embodiment of the present disclosure, a PoS device may contain an input, for example, for automatically identifying the member using identification information. In such an embodiment, the PoS device may include without limitation: a RFID reader to receive a RF signal including the identification information from a RFID tag possessed by the member; a magnetic strip reader to receive the identification information from a magnetic strip on a card possessed by the member; a keypad to receive identification information, such as a personal identification number, typed in by the member; a biometric identification device to receive biometric identification information presented by the member; or the like.

In a further exemplary embodiment of the present disclosure, in block 803, the member may also confirm his or her identification by inputting secondary identification information, such as, for example, a personal identification number (PIN), password, or the like.

In still a further exemplary embodiment of the present disclosure, in block 803, the identification of the member may be authenticated. IN such an embodiment, identification information associated with the member, including, for example, the identification information and/or secondary information may be combined with other information, such as, for example, a MAC address associated with a PoS device, a unique identifier of a PoS module, and/or the like, and transmitted to a database management system, for example, to authenticate the identity of the member. The database management system may then use the combined information to access stored biometric information associated with the member. As an additional layer of security, for example, the member may also provide biometric information to be compared with the accessed, stored biometric information. Such a comparison may enable a one-to-one comparison of the biometric information provided by the member and the biometric information stored by the database management system.

In block 804, information associated with the member may be retrieved. In an exemplary embodiment of the present disclosure, the information associated with the member may be retrieved by using, for example, the identification information. In such an embodiment, the information associated with the member may include, for example, personal information, medical information, medical history, insurance information, payment preferences, and the like.

Personal information may include, without limitation, name address, phone number, emergency medical contact information, social security number, employer name, and the like.

Medical information may include, without limitation, medical history, including medical history specific to the respective PoS and family medical history, known drug allergies, other treating physicians, prior prescriptions, image data associated with radiological images of the member, and the like.

Insurance information may include, without limitation, policy information, including identification of the insurance carrier, a policy number, policy constraints, copay information, prescription plan information, claim department information, and the like.

Payment preferences may include, without information, insurance claim preferences (i.e., primary and secondary carriers), credit card and/or debit card account information for paying any remaining portion of a bill associated with services provided.

In block 805, a member visit record may be created. In an exemplary embodiment of the present disclosure, the member visit record may include, for example, a computer file associated with a doctor's office visit, a hospital visit, or a pharmacy visit.

In block 806, if the PoS does not have a PoS device, the member may identify himself or herself to a PoS administrator, for example. In an exemplary embodiment of the present disclosure, the member may approach a reception area and present the administrator with identification. In such an embodiment, the identification may include, for example, a health insurance and/or prescription plan card, a driver's license, or like form of identification to the administrator.

In block 807, the administrator may log into a database management system, such as, for example, the database management system described above with respect to FIGS. 1 and 2. In an exemplary embodiment of the present disclosure, when the administrator logs into the database management system, the administrator may authenticate the identity of the administrator using, for example, a MAC address and/or a unique identifier associated with the administrator. For example, the administrator may be authenticated using a physicians identification number.

In one exemplary embodiment of the present disclosure, once the administrator logs into the database in block 807, flowchart 800 may proceed to block 804. In an alternative exemplary embodiment of the present disclosure, once the administrator logs into the database in block 807, flowchart 800 may optionally proceed to block 808, as is indicated by the dashed lines.

In block 808, it is determined whether an automatic identification device, such as one of the exemplary inputs described above in, for example, block 802, is available to the administrator.

If an automatic identification device is available to the administrator, in block 809, the administrator and/or member may use the automatic identification device to identify the member as is described above with respect to, for example, block 803. In an exemplary embodiment of the present disclosure, when the member has been authenticated, the administrator may be presented with, for example, a photo of the member stored within the database management system. Once the member is identified in block 809, flowchart 800 may proceed to block 804.

If an automatic identification device is not available to the administrator, in block 810, the administrator may enter member information to, for example, identify the member. Once the member is identified in block 810, flowchart 800 may proceed to block 804.

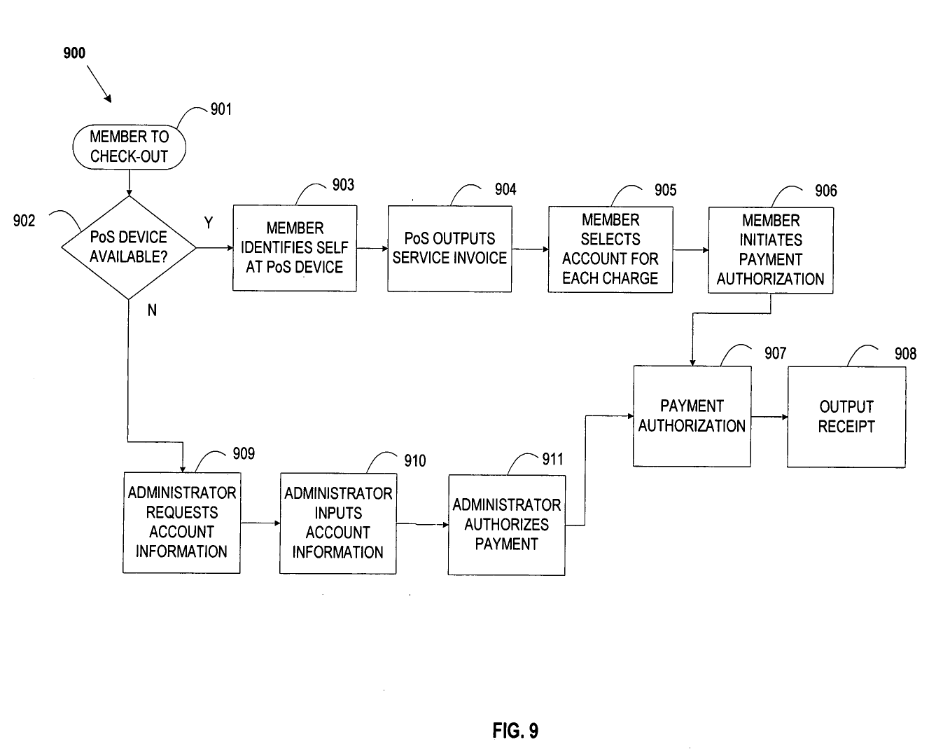

FIG. 9 depicts a flowchart 900 which illustrates an exemplary method for member check-out at a point of service (PoS) in accordance with an embodiment of the present disclosure.

In block 901, a member may proceed to check-out.

In block 902, a member may determine whether a PoS device is available at the PoS. In an exemplary embodiment of the present disclosure, a member may look for, for example, a kiosk, computer, or like device. In such an embodiment, a kiosk, computer, or like device may be available in, for example, a reception and/or check-out area in a doctor's office, any room of a hospital, or a prescription pick-up area of a pharmacy. If a PoS is available in block 902, flowchart 900 may proceed to block 903.

In block 903, a member may identify himself or herself at the PoS device. In an exemplary embodiment of the present disclosure, a PoS device may contain an input, for example, for automatically identifying the member using identification information. In such an embodiment, the PoS device may include without limitation: a RFID reader to receive an RFID signal including the identification information from a RFID tag possessed by the member; a magnetic strip reader to receive the identification information from a magnetic strip on a card possessed by the member; a keypad to receive identification information typed in by the member; a biometric identification device to receive biometric identification information presented by the member; or the like.

In a further exemplary embodiment of the present disclosure, in block 903, the member may also confirm his or her identification by inputting secondary identification information, such as, for example, a personal identification number (PIN), password, or the like. In still a further exemplary embodiment of the present disclosure, a member's identity may be authenticated as described above.

In block 904, the PoS device may provide a service invoice to the member. In an exemplary embodiment of the disclosure, the PoS device may, for example, display the invoice to the member on a monitor or touch screen. In such an embodiment, the member may then review the invoice for correctness. Further, in such an exemplary embodiment, a claim is submitted to the member's insurer via a connection through the Clearwave network that connects the Kiosk to the insurer. This connection is established through the Clearwave network via the Clearwave EDI subsystem in the form of HIPAA compliant transactions sets. Clearwave utilizes a combination of information obtained during the visit that speeds claim submission, 837 transaction, while reducing errors thus accelerating payment or reconciliation to the provider, via the 835 transaction. The information gathered starts with the administration setup of the kiosk and/or the provider portal. The key information available is Provider Tax ID, zip code, provider plan number which is the start of the 837. Added to the 837 is the 270 response, the 271 transaction which contains the eligibility information. To complete the 837 transaction the visit information is needed, such as procedure codes, ICD9 or other codes along with the number of units. The process reduces errors by limiting the amount of manual input. The only information that is manually entered is the visit details; basically, codes and number of units. Therefore all the administrative tasks of provider, payor and member information is handled electronically. In block 905, the member may select an account for payment of each charge. In an exemplary embodiment of the present disclosure, account information corresponding to, for example, bank or other financial accounts of the member may be previously stored. This account information may be presented to the member so that he or she may select which account is to be used to pay the remaining balance, for example. To select which account is to be used, in an exemplary embodiment of the present disclosure, the user may use a touch screen, keypad, or like device on the PoS device.

In block 906, the member may initiate payment authorization. In an exemplary embodiment of the present disclosure, the member may be prompted to initiate payment authorization on the display or touch screen, for example. In response to this prompt, to initiate payment authorization, the member may touch a button on the screen or keypad once the member is satisfied with the invoice.

In block 907, payment may be authorized. In an exemplary embodiment of the present disclosure, to authorize payment, the PoS device may communicate with a financial services module, for example, to process the transaction. In such an embodiment, the PoS device may transmit the account information via a network, for example, to the financial services module so that a transaction processor may authorize the payment.

In block 908, a receipt may be output. In an exemplary embodiment of the present disclosure, the receipt may be printed on paper, displayed on the PoS device, mailed, or emailed to the member, for example.

In block 902, if a PoS device is not available to the member, an administrator may request account information from the member in block 9089 In response to this request, the member may provide the administrator with account information.

In block 910, the administrator may input account information into a database management system as described above with respect to FIGS. 1 and 2, for example.

In block 911, the administrator may authorize payment. In an exemplary embodiment of the present disclosure, once the administrator authorizes payment in block 911, flowchart 900 may proceed to block 907.

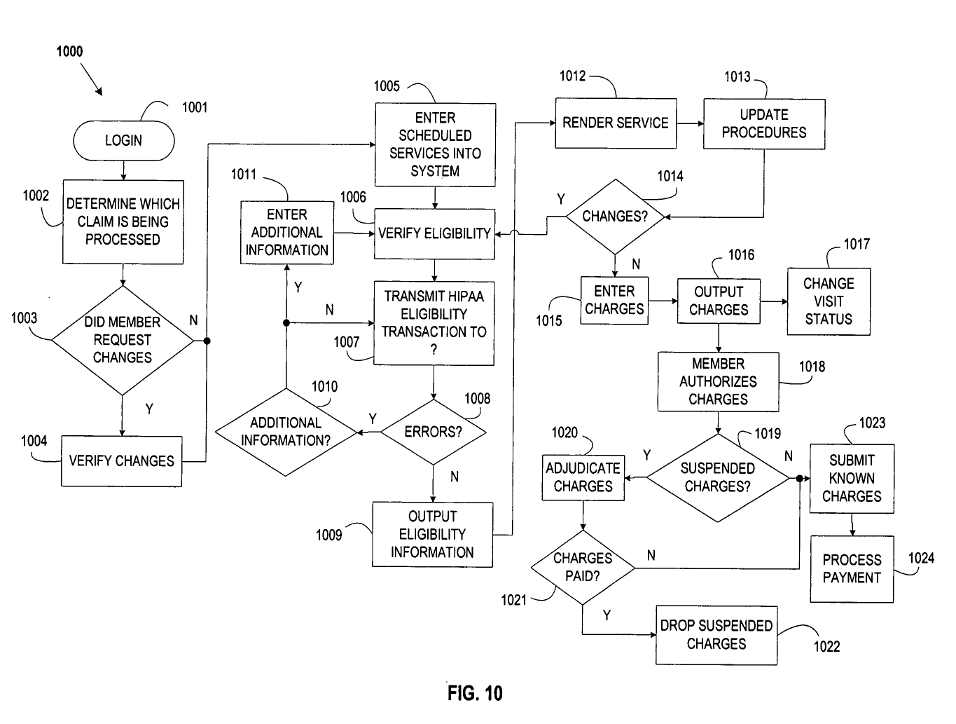

FIG. 10 depicts a flowchart 1000 which illustrates an exemplary method for automatic and/or electronic processing of a health-related transaction in accordance with an embodiment of the present disclosure.

In block 1001, an administrator, for example, may login to a database management system. In an exemplary embodiment of the present disclosure, the administrator may login to, for example, a database management system as described above with respect to FIGS. 1 and 2 using, a software application such as, for example, a web-based application, that may be a component of a PoS module.

In block 1002, an administrator, for example may determine which claim is to be processed. In an exemplary embodiment of the present disclosure, to determine which claim is to be processed, for example, the administrator may be presented with a list of members who have checked-in, the administrator may select which member's claim is to be processed, and the administrator may then be presented with information associated with the member visit.

In block 1003, it may be determined whether the member requested any changes to any information related to the insurance claim, for example, during member check-in, for example.

In block 1004, the changes made may be verified by the member. In an exemplary embodiment of the present disclosure, the administrator may, for example, consult with the member to verify any changes made as described above with respect to block 1003.

In block 1005, the administrator, for example, may enter scheduled services into the database management system. In an exemplary embodiment of the present disclosure, the member may have an intended purpose for visiting a doctor's office, hospital, or the like. In such an embodiment, in block 1005, the administrator may, for example, enter services into the database management system by typing text into a text field or selecting from a list of pre-determined services using, for example, drop down menus or radio buttons.

In block 1006, the eligibility of the member may be verified. In an exemplary embodiment of the present disclosure, a system for automatically and/or electronically processing a health-related transaction may use, for example, identification information associated with the member to retrieve insurance information associated with the member (for example, insurance coverage information, insurance policy constraints, and the like) and may process the insurance information to determine whether the member is eligible for insurance coverage.

In block 1007, a HIPAA compliant 270 request may be transmitted directly to the member's payor or to a regional or national EDI clearinghouse for example, WebMD, Availity, PerSe, as well as others.

In block 1008, it may be determined whether there are any errors associated with the processing of insurance information. If it is determined that there are errors associated with the processing of insurance information, flowchart 1000 may proceed to block 1010 to determine whether additional information may be needed to verify eligibility, for example.

In block 1010, if it is determined that additional information is needed, flowchart 1000 may proceed to block 1011, where the additional information may be entered by, for example, the member and/or administrator. Once the additional information has been entered in block 1011, flowchart 1000 may proceed to block 1006, for example.

In block 1010, if it is determined that additional information is not needed, flowchart 1000 may proceed to block 1007.

In block 1008, if it is determined that there are no errors associated with the processing of insurance information, flowchart 1000 may proceed to block 1009. In block 1009, insurance eligibility information may be output. In an exemplary embodiment of the for example, disclosure, to output the insurance eligibility information, the information may be displayed on a monitor or like device for the administrator and/or member to review, for example.

In block 1012, services may be rendered.

In block 1013, if the services rendered are not consistent with the services entered in block 1005, for example, the services may be updated to be consistent with the services rendered.

In block 1014, it is determined whether there are have been any changes in the services rendered. If, for example, in block 1013, services were updated to be consistent with the services rendered, flowchart 1000 may proceed to block 1006. If, in block 1013, there were no changes in the services rendered, flowchart 1000 may proceed to block 1015.

In block 1015, the charges associated with the services rendered may be entered into, for example, the database management system. In an exemplary embodiment of the present disclosure, the administrator, for example, may enter such charges. In an alternative exemplary embodiment of the present disclosure, the charges may be retrieved from a database and automatically entered based on the services rendered.

In block 1016, the charges associated with the services rendered may be output. In an exemplary embodiment of the present disclosure, the charges associated with the services rendered may be displayed on a monitor or like device for the administrator and/or member to review, for example.

In block 1017, member visit status may be changed to indicate that the member is ready for check-out. In an exemplary embodiment of the present disclosure, to change the member status, for example, a flag or like data structure may be set to indicate such a change in status.

In block 1018, the charges for services rendered may be authorized by the member. In an exemplary embodiment of the present disclosure, the member may use, for example, a PoS device such as, the PoS device described above with respect to FIG. 3 to authorize the charges. In such an embodiment, the member may use, for example, a monitor or touch screen on the PoS device to review the charges and a keypad, touch screen or like device to initiate the authorization process.

In block 1019, it may be determined whether there are any suspended charges; these charges are associated with any suspended charges related to the check-in process at the PoS device. PoS device has the ability to request a suspended transaction at the time of check-in to ensure patient has the ability to pay for services. If there are no suspended charges, flowchart 1000 may proceed to block 1023. If there are suspended charges, flowchart 1000 may proceed to block 1020.

In block 1020, the charges may be adjudicated. In an exemplary embodiment of the present disclosure, to adjudicate the charges, a payor may determine which charges are to be paid. Provider can determine the cost per visit by multiple methods per visit, per service or by the know payment per service per payor. The per visit can be accomplished through a set charge at the time of check-in at the PoS device that suspends charges, block 1019. Per Service is accomplished through additional 270 transactions that include service codes (procedure codes, ICD9 or others) in which the payor response with pricing information. The third is the knowledge that the administrative staffs have related to each service and the payors payment schedule for each. In this example those charges are manually entered in the Provider portal. All of these examples are integrated with the PoS device for payment by the member at the time of check-out. The result of this process feeds directly into the submission of the 837 transaction, block 904.

In block 1021, it is determined whether the charges are paid by, for example, the payor. If the charges are paid, flowchart 1000 may proceed to block 1022, where the suspended charges may be dropped by the administrator, for example. If the charges are not paid, flowchart 1000 may proceed to block 1023.

In block 1023, the charges may be submitted to a financial institution, for example, for payment. In an exemplary embodiment of the present disclosure, the administrator may automatically and/or submit the charges over, for example, a network to the financial institution.

In block 1024, the payment may be processed by, for example, the financial institution. In an exemplary embodiment of the present disclosure, the financial institution may automatically and/or electronically transmit payment, credit, and or debit accounts associated with the processing of the claim. In such an embodiment, a pre-tax medical account may also be debited to cover payment for services, for example.

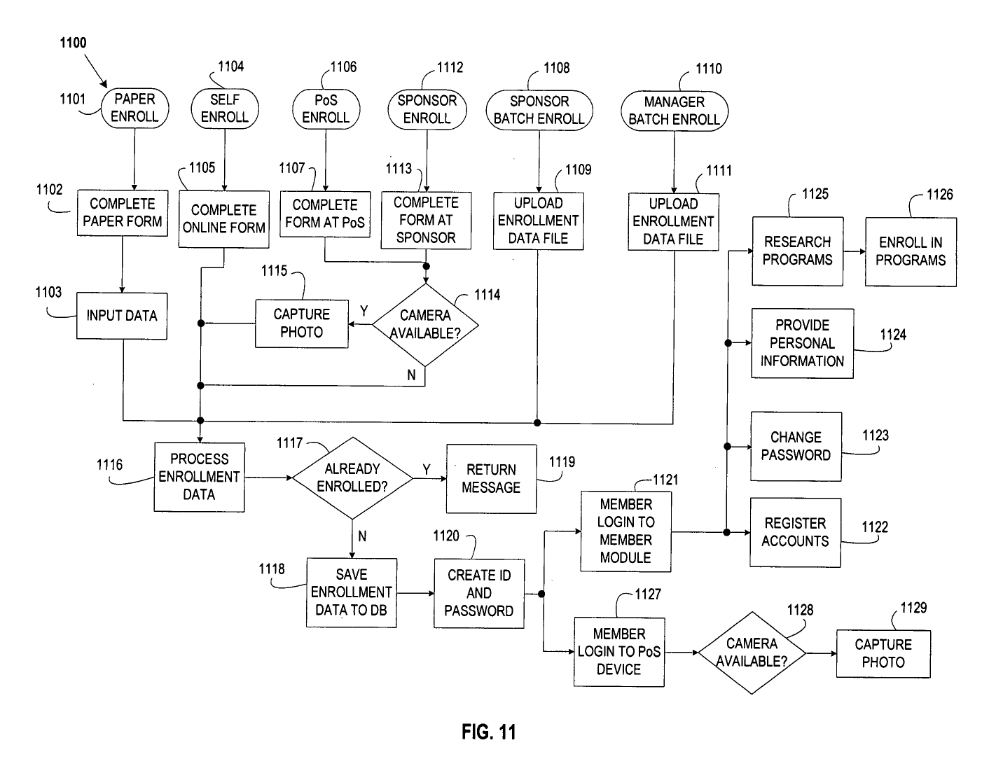

FIG. 11 depicts a flowchart 1100 which illustrates an exemplary method for enrolling into a system for automatic and/or electronic processing of a health-related transaction in accordance with an embodiment of the present disclosure.

In an exemplary embodiment of the present disclosure, a member may use several different methods for enrolling into a system for automatic and/or electronic processing of a health-related transaction, such as, for example, the system described above with respect to FIG. 1. In such an embodiment, a member may, for example, enroll by submitting paper forms, self-enroll via, for example, a web-based portal or the like, enroll at a PoS, enroll at a sponsor's organization, be enrolled by a sponsor using, for example, a batch enrollment process, or be enrolled by a program manager, for example, using a batch enrollment process.

In block 1101, a member may enroll by submitting paper forms.

In block 1102, the member may complete the paper form and transmit the form to, for example, a program administrator, sponsor or like person for manual data entry.

In block 1103, the data from the paper form may be manually entered into the system. Once the data has been manually entered into the system, flowchart 1100 may proceed to block 1116.

In block 1104, a member may self-enroll.

In block 1105, to self-enroll, a member may complete online forms. In an exemplary embodiment of the present disclosure, a member may use, for example, a member module as described above with respect to FIG. 5, to enroll. In such an embodiment, the member may complete online forms using, for example, a web browser or web-based application, and transmit those forms to, for example the system. Once the online forms have been transmitted to the system, flowchart 1100 may proceed to block 1116.

In block 1106, a member may enroll at a PoS. In an exemplary embodiment of the present disclosure, a member may enroll at a PoS, such as the PoS discussed above with respect to FIG. 3, using, for example, a PoS device or integration module.

In block 1107, to enroll at a PoS, the member may complete electronic forms using, for example, a web browser or web-based application on a PoS device or integration module, and transmit those forms to, for example the system. Once the electronic forms have been transmitted to the system, flowchart 1100 may proceed to block 1114.

In block 1108, a sponsor may enroll a member or plurality of members. In an exemplary embodiment of the present disclosure, the sponsor may, for example, enroll the member or plurality of members using a batch enroll process. In such an embodiment, to complete a batch enroll process, in block 1109 the sponsor may upload a file containing a group of enrollment records, for example, to the system for processing together. Once the file has been uploaded to the system, flowchart 1100 may proceed to block 1116.

In block 1110, a program manager may enroll a member or plurality of members. In an exemplary embodiment of the present disclosure, the program manager may, for example, enroll the member or plurality of members using a batch enroll process. In such an embodiment, to complete a batch enroll process, in block 1111 the program manager may upload a file containing a group of enrollment records, for example, to the system for processing together. Once the file has been uploaded to the system, flowchart 1100 may proceed to block 1116.

In block 1112, a member may enroll at a sponsor's organization, such as the sponsor module discussed above with respect to FIG. 4, using, for example, a device coupled to the sponsor's intranet or an integration module.

In block 1113, to enroll at a sponsor module, the member may complete electronic forms using, for example, a web browser or web-based application on the device or integration module, and transmit those forms to, for example, the system. Once the electronic forms have been transmitted to the system, flowchart 1100 may proceed to block 1114.

In block 1114, it may be determined whether there is a camera available. In an exemplary embodiment of the present disclosure, a digital camera, for example, may be coupled to a device in the sponsor module or PoS for the purpose of taking identification images of the member. In an alternative exemplary embodiment, it may be determined whether other devices may be available for the purposes of receiving identification information of the member. For example, other devices may include biometric readers to take retinal scans, thumb prints, voice prints, or the like, and use such information as identification information. If a camera or like device is available in block 1114, flowchart 1100 may proceed to block 1115, where the picture or other identification information of the member may be captured. If the camera or like device is not available in block 1114, flowchart 1100 may proceed to block 1116.

In block 1116, the enrollment data may be processed.

In block 1117, to process enrollment data, it may be determined whether the member is already enrolled. If the member is already enrolled, in block 1119, a message may be returned to the member, sponsor, or manager attempting to enroll the member indicating that the member is enrolled.

If the member is not enrolled, in block 1118, the enrollment data may be saved in, for example, a membership database included within the system. In an exemplary embodiment of the present disclosure, the membership database may be similar to the databases described above with respect to FIG. 2.

In block 1120, a membership identification and password may be created. In an exemplary embodiment of the present disclosure, each member enrolled into the system may have an account that may be used for automatically and/or electronically processing a health-related transaction. In such an embodiment, this account may be stored in the system, and the information within the account may be accessed and used by, for example, members, sponsors, managers, financial institutions, and the like.

In block 1121, a member may access his or her account by, for example, logging in at a member module. In an exemplary embodiment of the present disclosure, a member may access his or her account via a member module, for example, such as the member module described above with respect to FIG. 5.

In block 1122, a member may register payment accounts. In an exemplary embodiment of the present disclosure, a member may, for example, provide information to the system about personal accounts from which payment for services may be made. In such an embodiment, the information may include information about bank accounts (i.e., checking and/or savings accounts), debit card accounts, credit cards accounts, pre-tax medical accounts, and the like.

In block 1123, a member may change the password to his or her account.

In block 1124, a member may provide personal information to be stored in the account.

In block 1125, a member may use the system, for example, to research programs, such as insurance coverage programs, that may be available to the member.

In block 1126, a member may enroll in such programs. In an exemplary embodiment of the disclosure, the member may enroll in programs via an online enrollment process, for example.

In block 1127, a member may login to a PoS device. In an exemplary embodiment of the present disclosure, a member may present identification information to login.

In block 1128, it may be determined whether there is a camera available. In an exemplary embodiment of the present disclosure, a digital camera, for example, may be coupled to a device in the sponsor module or PoS for the purpose of taking identification images of the member. In an alternative exemplary embodiment, it may be determined whether other devices may be available for the purposes of receiving identification information of the member. For example, other devices may include biometric readers, to take retinal scans, thumb prints, voice prints, or the like and use such information as identification information. If a camera or like device is available in block 1128, flowchart 1100 may proceed to block 1129, where the picture or other identification information of the member may be captured.

Alternative Exemplary Embodiments

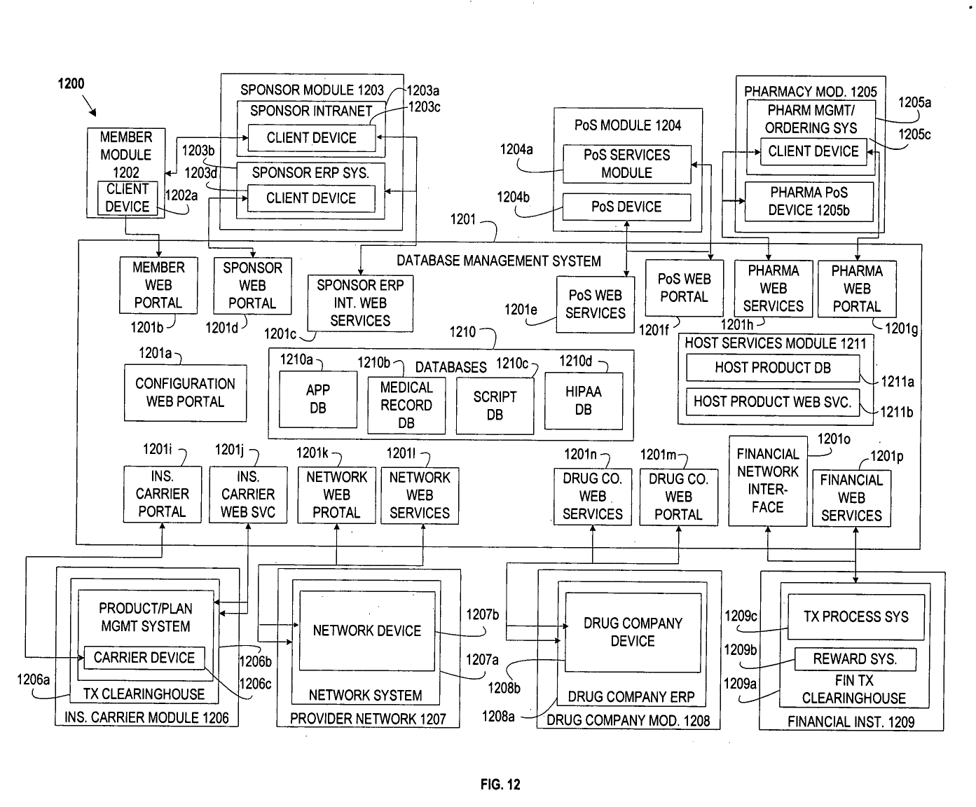

FIG. 12 depicts an exemplary embodiment of a system 1200 for automatically and/or electronically processing a claim according to an embodiment of the present disclosure. In an exemplary embodiment, system 1200 may be a network-based system. In such an embodiment, the modules and/or components may be couple to each other via any one of a number of network connections, including but not limited to an intranet connection, a Local Area Network (LAN) connection, a Wide Area Network (WAN) Connection, the Internet (for example, World Wide Web), a wireless network, a Bluetooth connection, and the like.

As is shown in FIG. 12, system 1200 may include a database management system 1201, a member module 1202, a sponsor module 1203, a PoS module 1204, a pharmacy module 1205, an insurance carrier module 1206, a provider network 1207, a drug company module 1208, and a financial institution 1209.

In an exemplary embodiment of the present disclosure, database management system 1201 may include databases 1210, hosted services module 1211, configuration web portal 1201a, member web portal 1201b, sponsor enterprise resource planning (ERP) integration web services 1201c, sponsor web portal 1201d, PoS web services 1201e, PoS web portal 1201f, pharmacy web portal 1201g, pharmacy web services 1201h, insurance carrier web portal 1201i, insurance carrier product integration web services 1201j, network web portal 1201k, network web services 1201l, drug company web portal 1201m, drug company web services 1201n, financial network interface 1201o, and financial web services 1201p.

In such an embodiment, the web portals may enable communication between the respective modules and the database management system 1201. Further, the web services, integration web services and the like, may enable integration between systems of the respective modules and the data management system 1201.

In an exemplary embodiment of the present disclosure, configuration web portal 1201a may include, for example, hardware and/or software to enable, for example, a database administrator to configure and manage system 1200.

Databases 1210 may include an applications database 1210a, a medical records database 1210b, a prescription database 1210c, and a HIPAA compliant/audit/reporting database 1210d. In an exemplary embodiment of the present disclosure, these databases may be similar to databases described above with respect to FIG. 2, for example.

Hosted services module 1211 may include a hosted products database 1211a and hosted product web services 1211b.

As is shown in FIG. 12, member module 1202 may include a client device 1202a. In an exemplary embodiment of the disclosure, client device 1202a may communicate with and enable access to database management system 1201, for example. In such an embodiment, client device 1202a may be coupled to member web portal 1201b and sponsor module 1203.

Sponsor module 1203 may include a sponsor intranet 1203a and sponsor ERP system 1203b. In an exemplary embodiment of the disclosure, each of the sponsor intranet 1203a and sponsor ERP system 1203b may include a client device 1203c, 1203d, respectively, that may enable communication with database management system 1201. In such an embodiment, client device 1203c may be coupled to sponsor ERP web services 1201c, and client device 1203d may be coupled to sponsor ERP web services 1201c and/or sponsor web portal 1201d.

Pos module 1204 may include a Pos device 1204b coupled to PoS web services 1201e, and PoS services module 1204a coupled to PoS web portal 1201f. In an exemplary embodiment of the present disclosure, PoS module 1204 may be similar to the PoS module described above with respect to FIG. 3, for example.

Pharmacy module 1205 may include a pharmacy management and ordering system 1205a and a pharmacy PoS device 1205b. In an exemplary embodiment of the present disclosure, pharmacy management and ordering system 1205a may include a client device 1205c which may be coupled to pharmacy web portal 1201g and pharmacy web services 1201h. Pharmacy PoS device 1205b may be coupled to pharmacy web services 1201h. In an exemplary embodiment of the present disclosure, pharmacy PoS device may be similar to the PoS module described above with respect to FIG. 3, for example. In such an embodiment, pharmacy module 1205 may automatically and/or electronically process a prescription transaction associated with a prescription plan.

In an exemplary embodiment of the present disclosure, insurance carrier module 1206 may include an insurance transaction clearinghouse 1206a, a product and plan management system 1206b and a carrier device 1206c. In such an embodiment, insurance transaction clearinghouse 1206a and product and plan management system 1206b may be coupled to insurance carrier product integration web services 1201j, and carrier device 1206c may be coupled to insurance carrier web 1201i.

Provider networks 1207 may include a network system 1207a and a network device 1207b. In an exemplary embodiment of the present disclosure, network system 1207a may be coupled to network web services 12011 and network web portal 1201k, and network device 1207b may be coupled to network web portal 1201k and network web services 1201l.

Drug company module 1208 may include a drug company ERP system 1208a and a drug company device 1208b. In an exemplary embodiment of the present disclosure drug company ERP system 1208a may be coupled to drug company web services 1201n and drug company web portal 1201m, and drug company device 1208b may be coupled to drug company web portal 1201m and drug company web services 1201n.

In an exemplary embodiment of the present disclosure, financial institution 1209 may include a financial transaction clearinghouse 1209a. In such an embodiment, financial transaction clearinghouse 1209a may include a reward processing system 1209b and a transaction processing system 1209c. Further, financial transaction clearinghouse 1209a may be coupled to financial transaction network interface 1201o and financial web services 1201p.

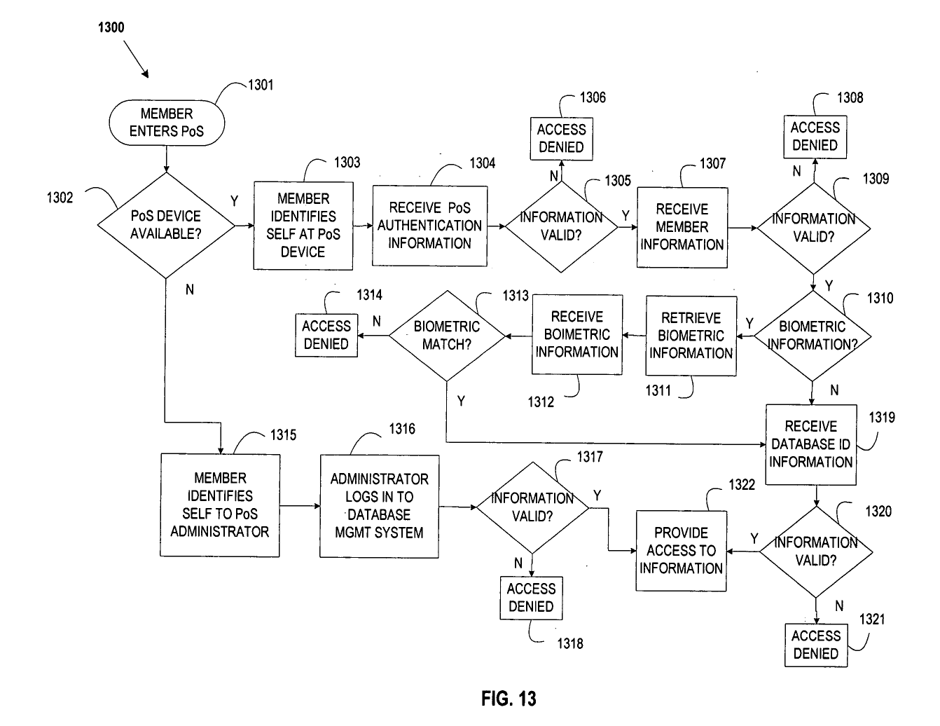

FIG. 13 depicts a flowchart 1300 which illustrates and an exemplary embodiment of a method for providing secure access to information according to an embodiment of the present disclosure. In an exemplary embodiment of the present disclosure, the information may be related to, for example, healthcare information, information related to processing a health-related transaction, transportation safety information, passport information, or any other like information that may require secure access to the information.

In block 1301, a member may enter a PoS. In an exemplary embodiment of the present disclosure, a PoS may include, for example, a doctor's office, a hospital, a pharmacy, an airport, or any other like location.

In block 1302, a member may determine whether a PoS device is available at the PoS. In an exemplary embodiment of the present disclosure, a member may look for, for example, a kiosk, computer, or like device. In such an embodiment, a kiosk computer, or like device may be available in, for example, a reception area in a doctor's office, any room of a hospital, a prescription drop-off area of a pharmacy, or a security check-point in an airport. If a PoS is available in block 1302, flowchart 1300 may proceed to block 1303. If a PoS device is not available, flowchart 1300 may proceed to block 1315.

In block 1303, a member may identify himself or herself at the PoS device. In an exemplary embodiment of the present disclosure, a PoS device may contain an input, for example, for automatically identifying the member using identification information. In such an embodiment, the PoS device may include without limitation; a RFID reader to receive a RF signal including the identification information from a RFID tag possessed by the member; a magnetic strip reader to receive the identification information from a RFID tag possessed by the member; a magnetic strip reader to receive the identification information from a magnetic strip on a card possessed by the member; a keypad to receive identification information typed in by the member; a biometric identification device to receive biometric identification information presented by the member; or the like.

In a further exemplary embodiment of the present disclosure, in block 1303, the member may also confirm his or her identification by inputting secondary identification information, such as, for example, a personal identification number (PIN), password, or the like.

In still a further exemplary embodiment of the present disclosure, in block 1303, the identification of the member may be authenticated. In such an embodiment, identification information associated with the member, including, for example, the identification information and/or secondary information may be combined with other information, such as, for example, a MAC address associated with a PoS device, a unique identifier of a PoS module, and/or the like, and transmitted to a database management system, for example, to authenticate the identity of the member. The database management system may then use the combined information to access stored biometric information associated with the member. As an additional layer of security, for example, the member may also provide biometric information to be compared with the accessed, stored biometric information. Such a comparison may enable a one-to-one comparison of the biometric information provided by the member and the biometric information stored by the database management system, as is described in further detail below.

In block 1304, PoS authentication information may be received. In an exemplary embodiment of the present disclosure, a database management system, for example, or the like may receive PoS authentication information. In such an embodiment the PoS authentication information may include, for example, a MAC address of the PoS device, an IP address of the PoS device, and/or an identifier of the administration, such as, for example, a physician identification number.

In block 1305, the PoS authentication information received may be validated. If the PoS authentication information is valid, flowchart 1300 may proceed to block 1307. If the PoS authentication information is not valid, access to the information may be denied in block 1306.

In block 1307, member information may be received. In an exemplary embodiment of the present disclosure, member information, including, for example, an identifier associated with the member and a related personal identification number (PIN) may be received by the database management system for authentication. In such an embodiment, the identifier may be associated with a RFID tag, a magnetic strip, biometric information, and/or the like.

In block 1309, the member information received may be validated. If the member information is valid, flowchart 1300 may proceed to block 1310. If the member information is not valid, access to the information may be denied in block 1308.

In block 1310, it may be determined whether biometric information may be used for validation. If biometric information may be used for validation, flowchart 1300 may proceed to block 1311. If biometric information is not available, flowchart 1300 may proceed to block 1319.

In block 1311, stored biometric information may be retrieved by the database management system. In an exemplary embodiment of the present disclosure, the database management system may use, for example, the member information to retrieve previously stored biometric information associated with the member.

In block 1312, input biometric information may be received by the database management system. In an exemplary embodiment of the present disclosure, a member, for example, may input biometric information using a PoS device. In such an embodiment, this input biometric information including, for example, a retinal scan, a finger print, a voice print, or a signature, may be transmitted to the database management system for authentication using, for example, a one-to-one comparison of the stored biometric information associated with the member and the input biometric information.

In block 1313, the stored biometric information may be compared with the input biometric information and it may be determined whether there exists a one-to-one match of the compared biometric information. If there is a match of the biometric information, flowchart 1300 may proceed to block 1320. If there is not a biometric match, access may be denied in block 1314.

In block 1315, if there is no PoS device available, a member may identify himself or herself to the PoS administrator.

In block 1316, an administrator may log on to the database management system and provide the system with member information.

In block 1317, the administrator information may be validated. In such an embodiment, a database management system may use, for example, the administrator login information, the member information, a unique identifier associated with a database of the administrator, and/or any other secure information to validate the administrator information. If the administrator is validated, flowchart 1300 may proceed to block 1322. If the administrator is not validated, access may be denied in block 1318.

In block 1319, database information may be received. In an exemplary embodiment of the present disclosure, a database management may receive a unique identifier associated with a database of the administrator.

In block 1320, the database information may be validated. If the database information is validated, flowchart 1300 may proceed to block 1322. If the database information is not validated, access may be denied in block 1321.

In block 1322, access to the information may be provided. In an exemplary embodiment of the present invention, a member, administrator, or the like, after being authenticated as described above, may be permitted to access information. Further, in alternative exemplary embodiments, access may be granted to, for example, secure areas based on such authentication techniques.

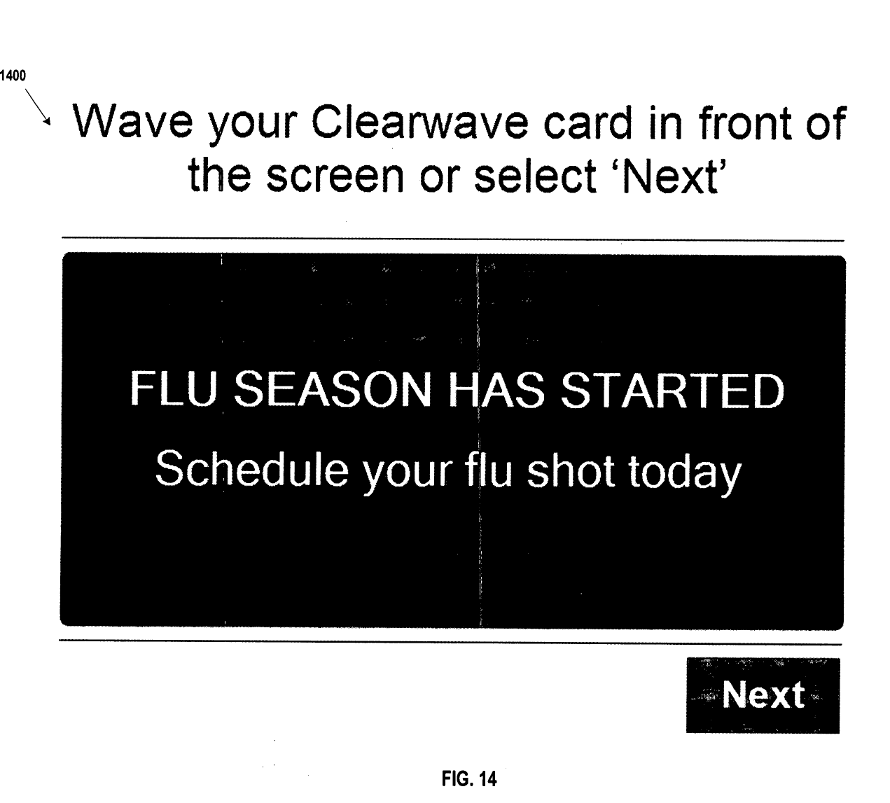

FIG. 14 depicts an exemplary embodiment of a screen display 1400 according to the present disclosure. In an exemplary embodiment of the present disclosure, screen display 1400 may depict a welcome screen on a PoS device.

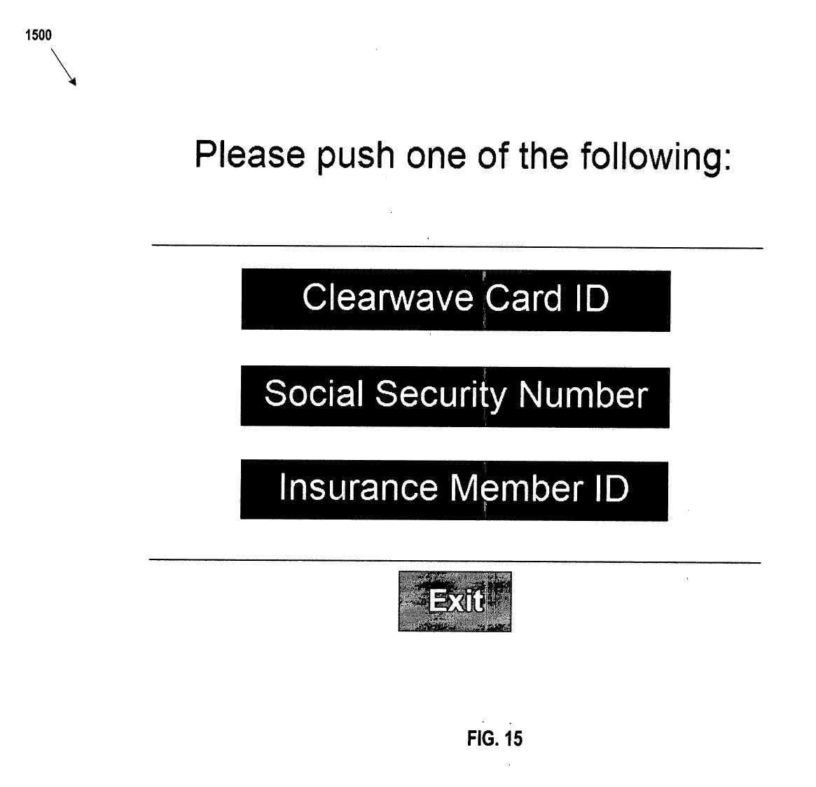

FIG. 15 depicts an exemplary embodiment of a screen display 1500 according to the present disclosure. In an exemplary embodiment of the present disclosure, screen display 1500 may depict an identification selection screen on a PoS device.

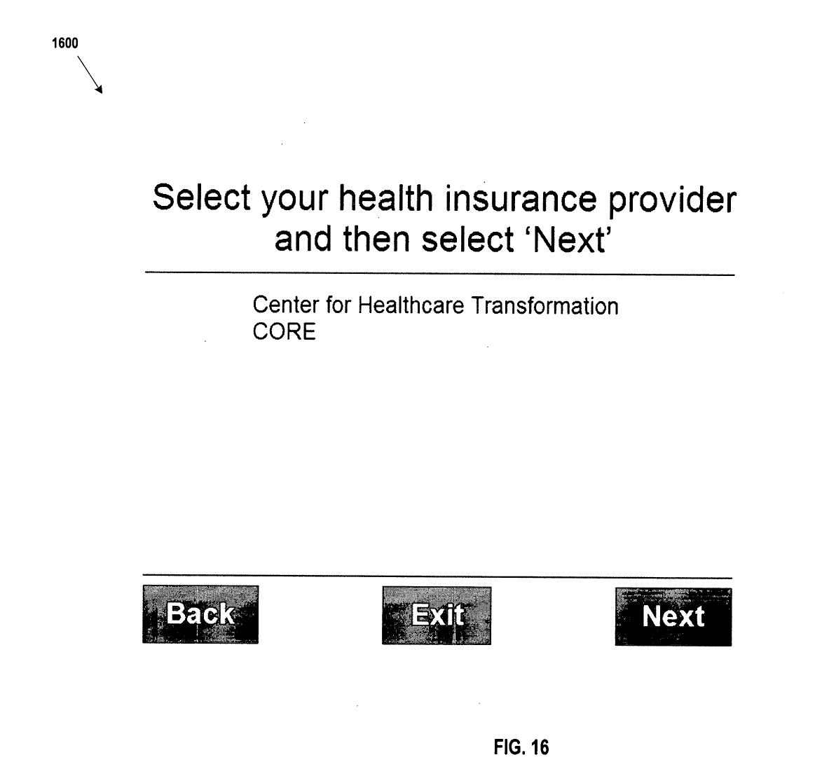

FIG. 16 depicts an exemplary embodiment of a screen display 1600 according to the present disclosure. In an exemplary embodiment of the present disclosure, screen display 1600 may depict an insurance provider selection screen on a PoS device.

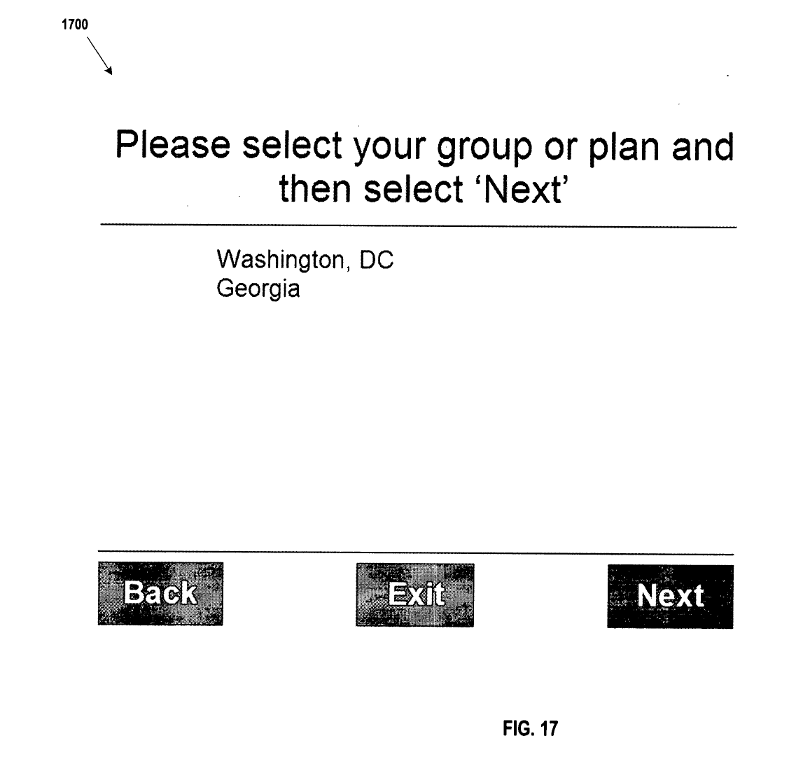

FIG. 17 depicts an exemplary embodiment of a screen display 1700 according to the present disclosure. In an exemplary embodiment of the present disclosure, screen display 1700 may depict a group selection screen on a PoS device.

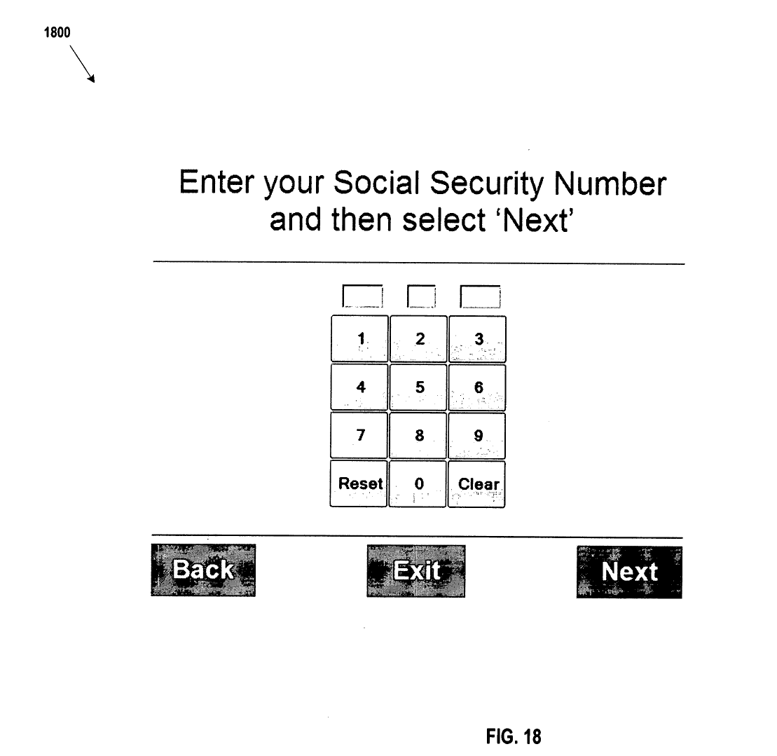

FIG. 18 depicts an exemplary embodiment of a screen display 1800 according to the present disclosure. In an exemplary embodiment of the present disclosure, screen display 1800 may depict a keypad screen on a PoS device.

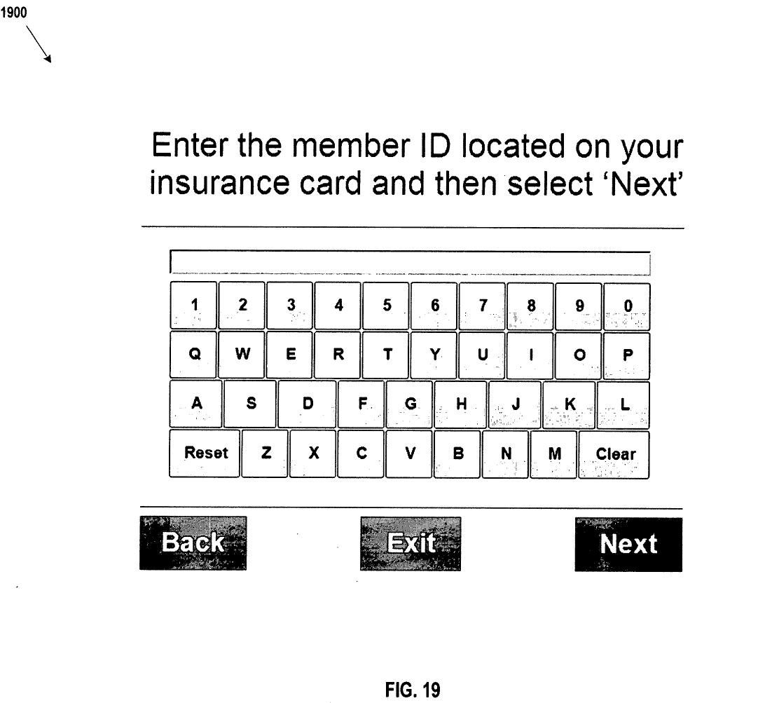

FIG. 19 depicts an exemplary embodiment of a screen display 1900 according to the present disclosure. In an exemplary embodiment of the present disclosure, screen display 1900 may depict a keypad screen on a PoS device.

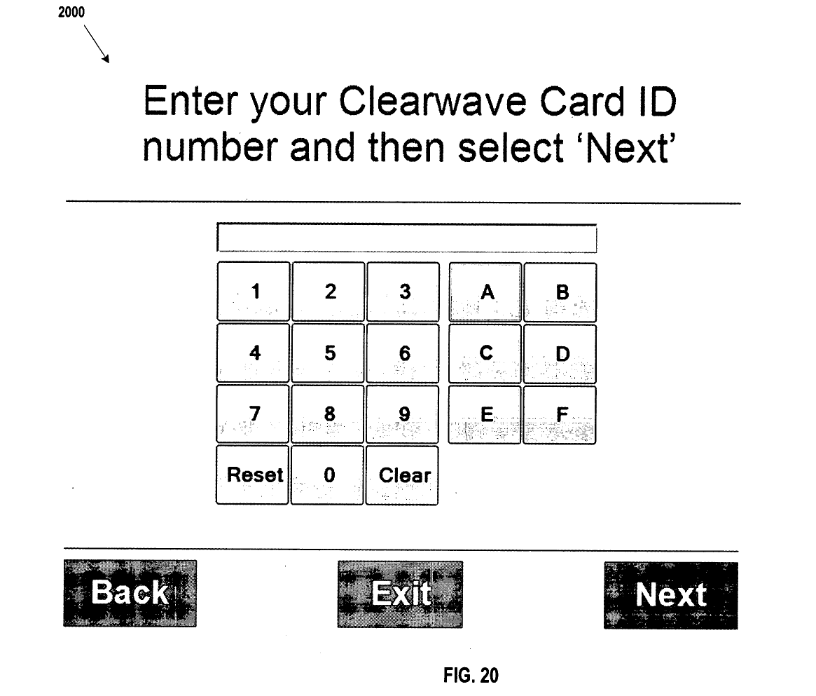

FIG. 20 depicts an exemplary embodiment of a screen display 2000 according to the present disclosure. In an exemplary embodiment of the present disclosure, screen display 2000 may depict a keypad screen on a PoS device.

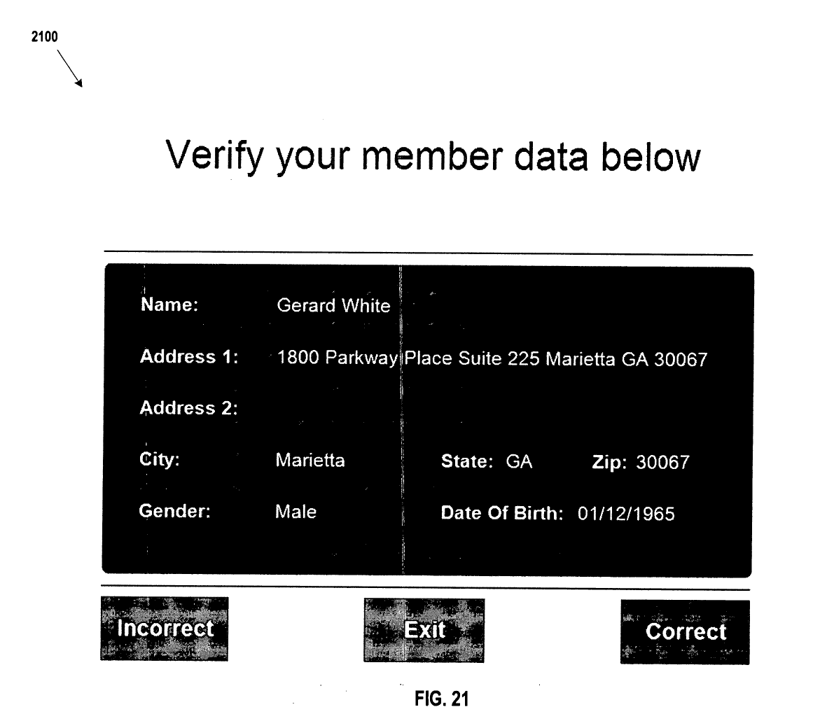

FIG. 21 depicts an exemplary embodiment of a screen display 2100 according to the present disclosure. In an exemplary embodiment of the present disclosure, screen display 2100 may depict a data verification screen on a PoS device.

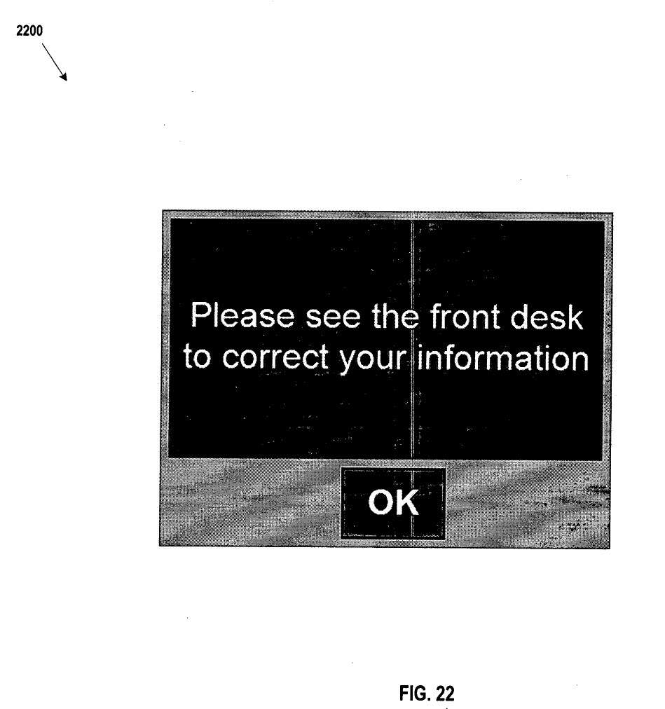

FIG. 22 depicts an exemplary embodiment of a screen display 2200 according to the present disclosure. In an exemplary embodiment of the present disclosure, screen display 2200 may depict a notification screen on a PoS device. In an exemplary embodiment of the present disclosure, a member may be notified, for example, if their identification cannot be authenticated.

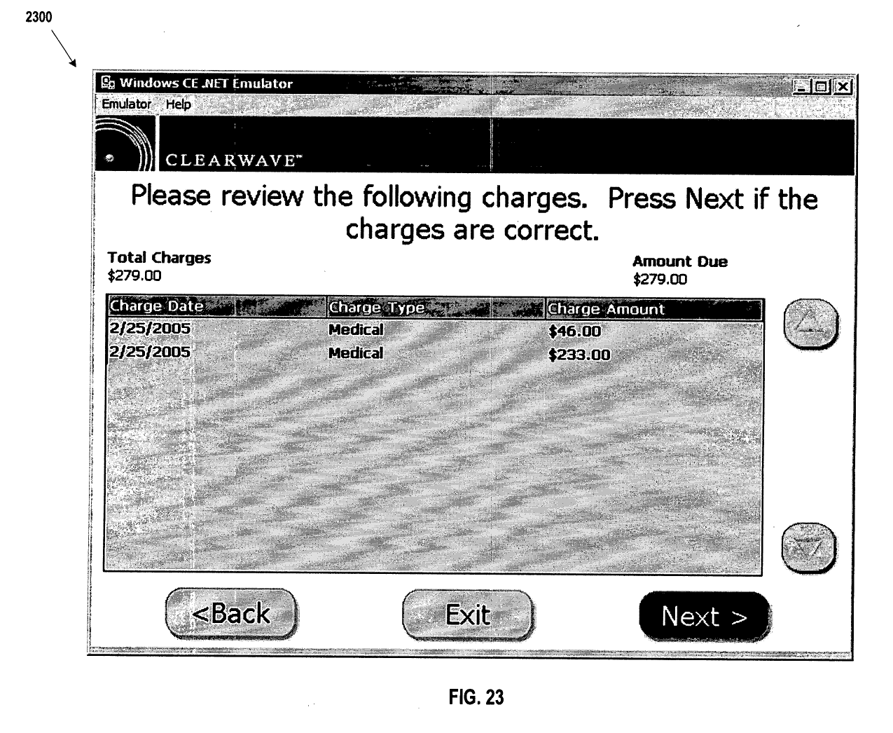

FIG. 23 depicts an exemplary embodiment of a screen display 2300 according to the present disclosure. In an exemplary embodiment of the present disclosure, screen display 2300 may depict a charges review screen on a PoS device.

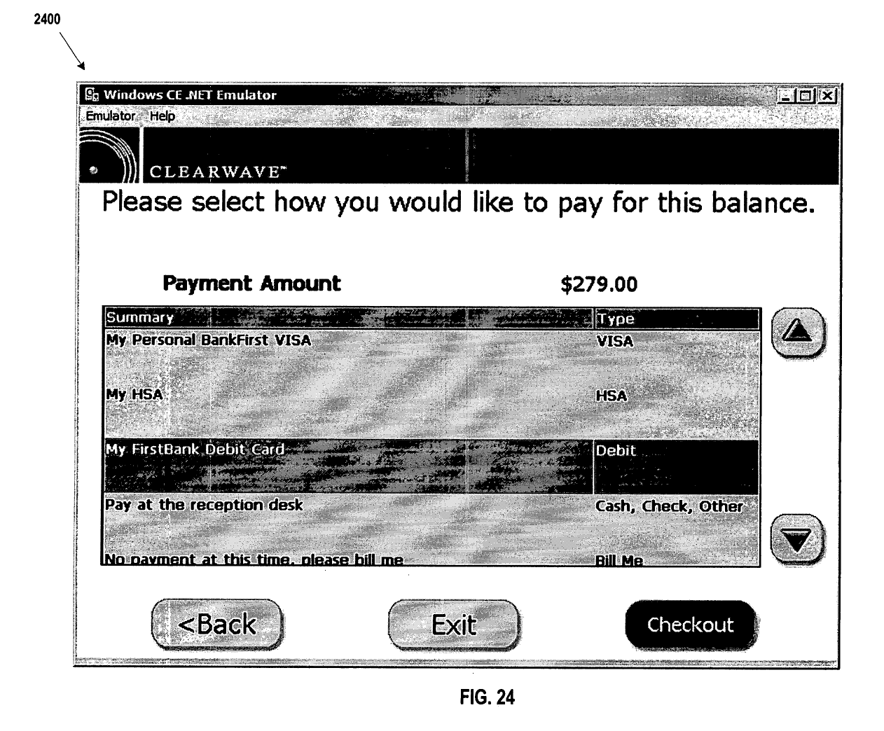

FIG. 24 depicts an exemplary embodiment of a screen display 2400 according to the present disclosure. In an exemplary embodiment of the present disclosure, screen display 2400 may depict a payment selection screen on a PoS device.

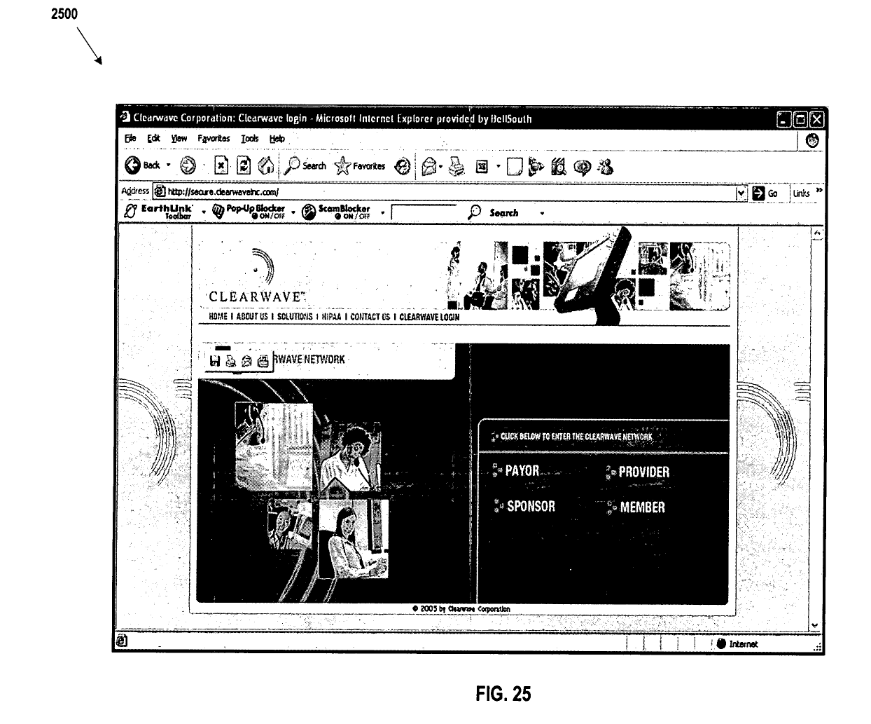

FIG. 25 depicts an exemplary embodiment of a screen display 2500 according to the present disclosure. In an exemplary embodiment of the present disclosure, screen display 2500 may depict a login screen.

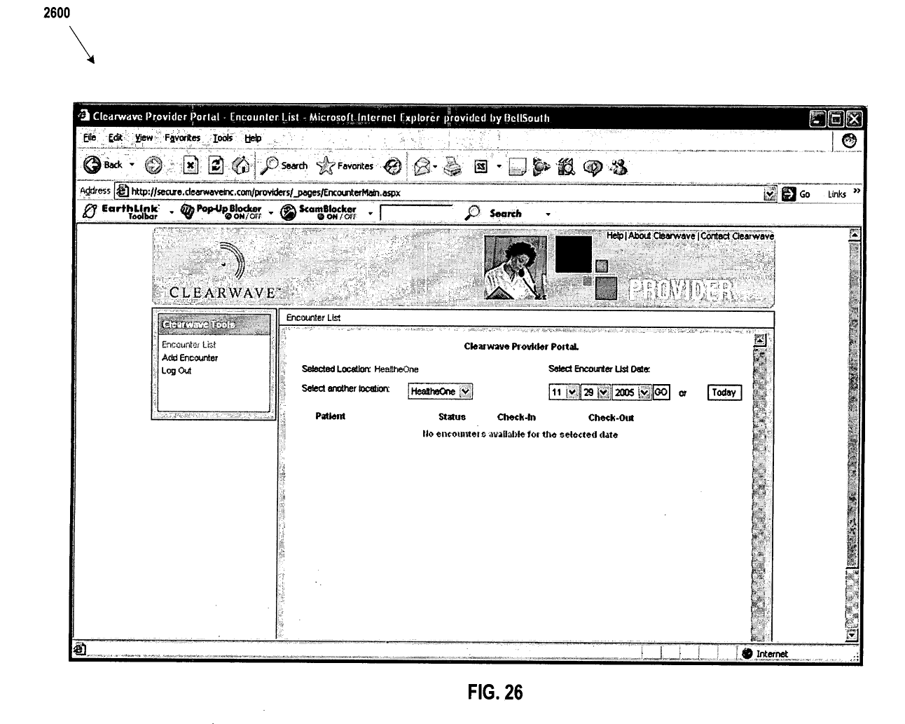

FIG. 26 depicts an exemplary embodiment of a screen display 2600 according to the present disclosure. In an exemplary embodiment of the present disclosure, screen display 2600 may depict a provider screen.

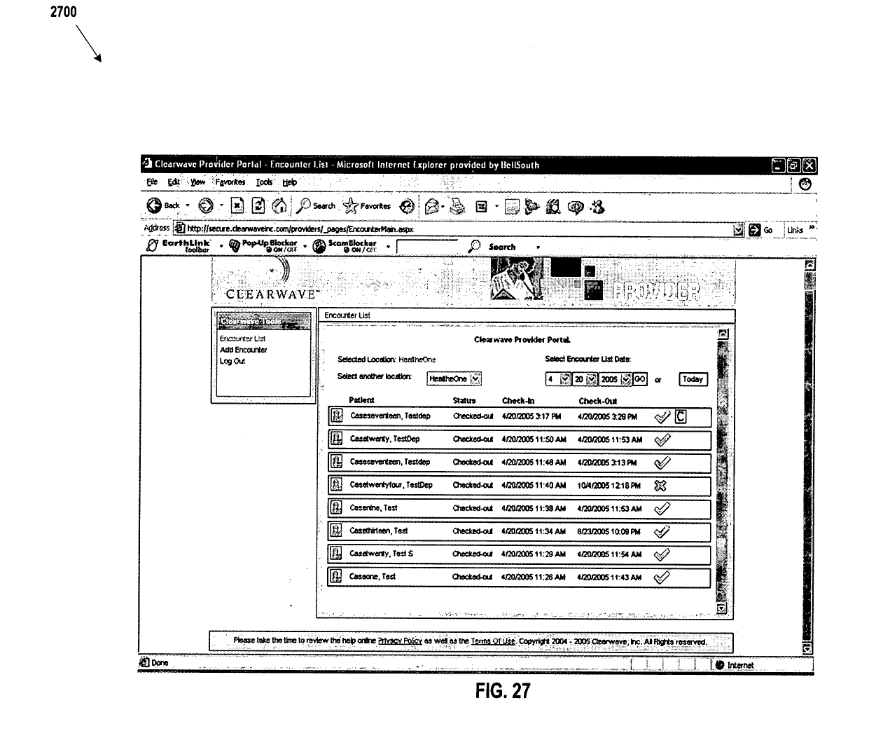

FIG. 27 depicts an exemplary embodiment of a screen display 2700 according to the present disclosure. In an exemplary embodiment of the present disclosure, screen display 2700 may depict a provider screen.

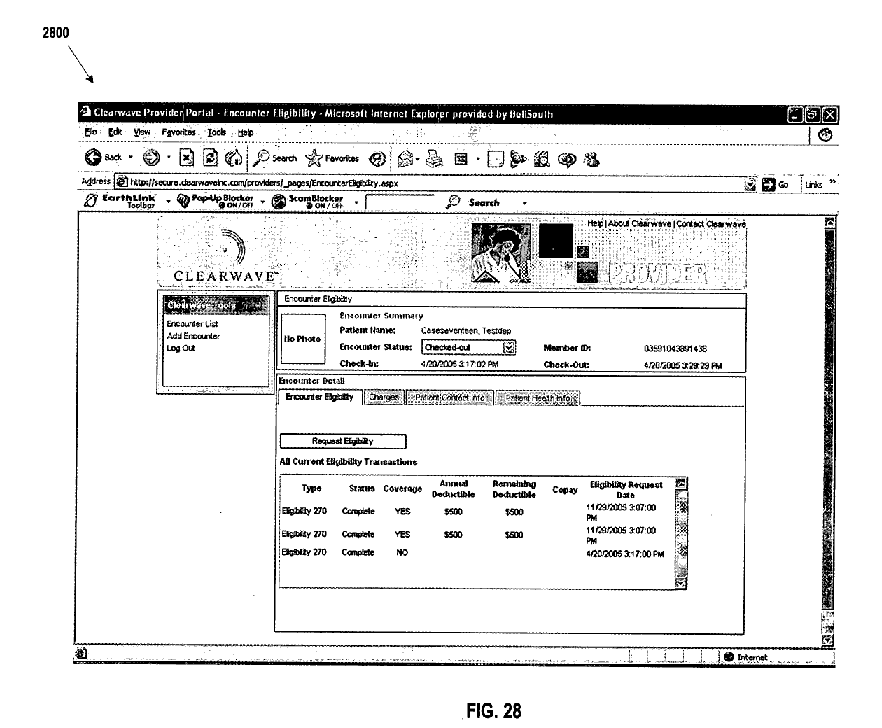

FIG. 28 depicts an exemplary embodiment of a screen display 2800 according to the present disclosure. In an exemplary embodiment of the present disclosure, screen display 2800 may depict a provider screen.

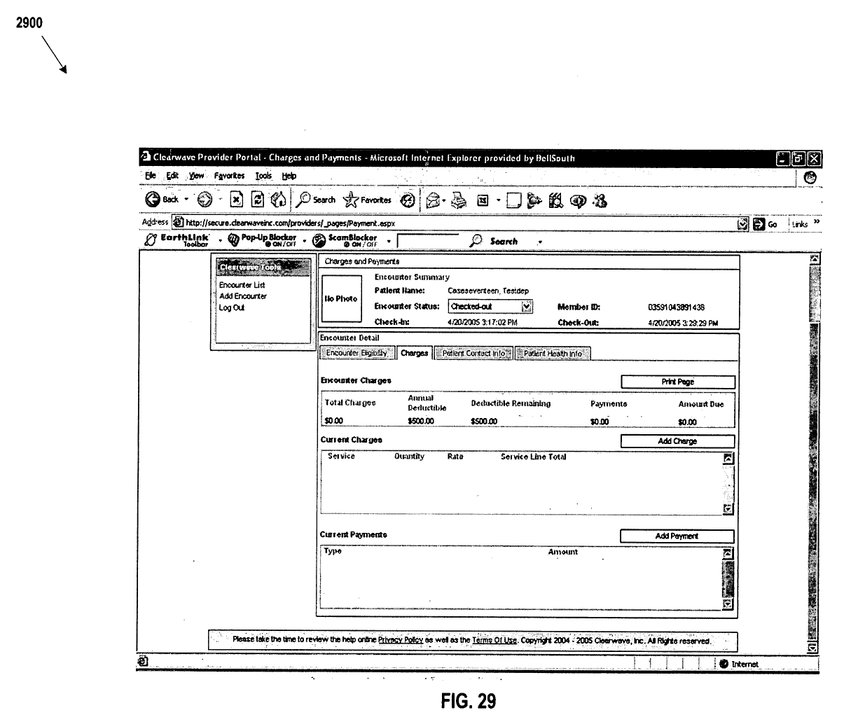

FIG. 29 depicts an exemplary embodiment of a screen display 2900 according to the present disclosure. In an exemplary embodiment of the present disclosure, screen display 2900 may depict a provider screen.

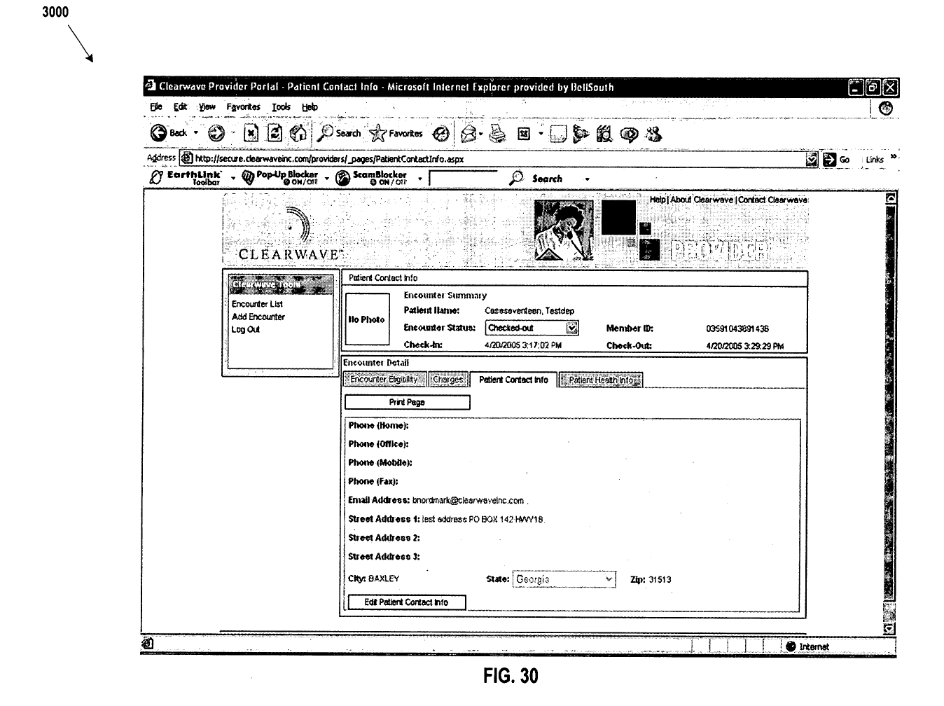

FIG. 30 depicts an exemplary embodiment of a screen display 3000 according to the present disclosure. In an exemplary embodiment of the present disclosure, screen display 3000 may depict a provider screen.

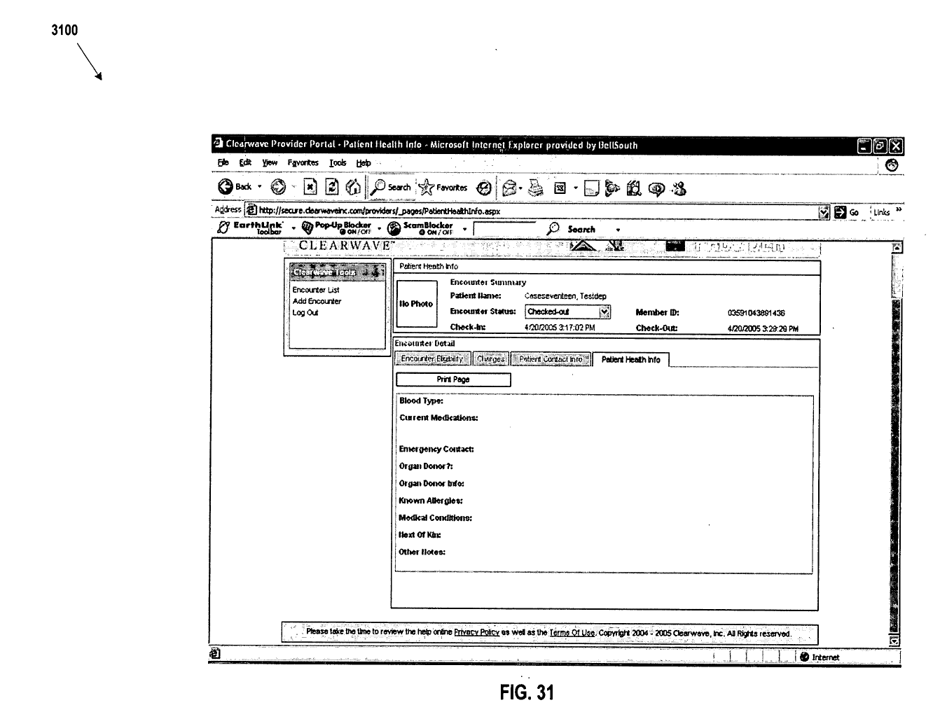

FIG. 31 depicts an exemplary embodiment of a screen display 3100 according to the present disclosure. In an exemplary embodiment of the present disclosure, screen display 3100 may depict a provider screen.

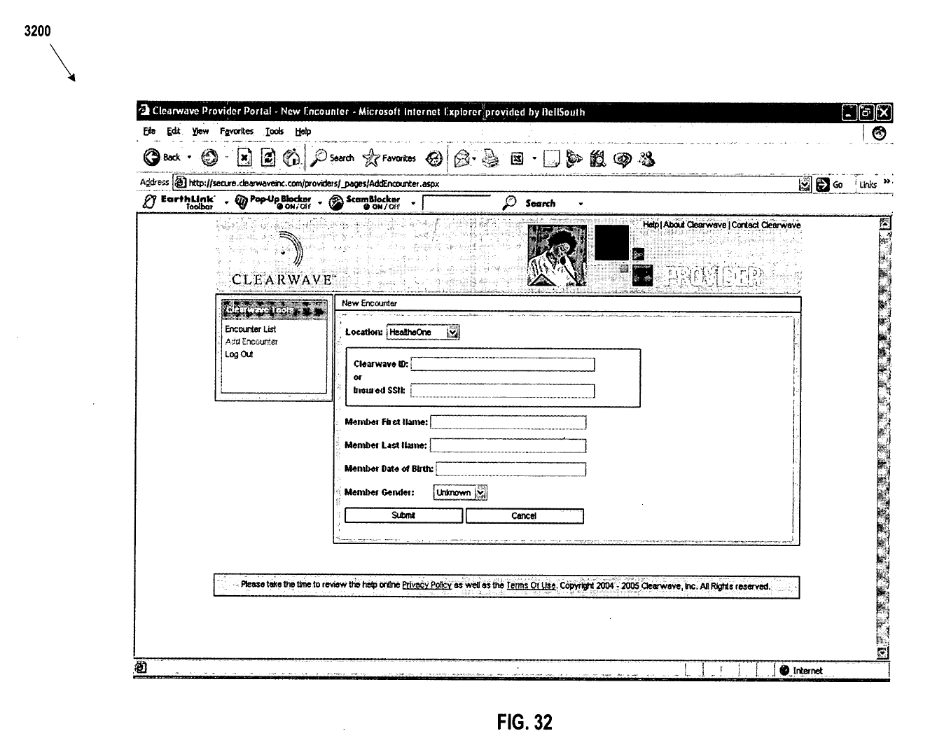

FIG. 32 depicts an exemplary embodiment of a screen display 3200 according to the present disclosure. In an exemplary embodiment of the present disclosure, screen display 3200 may depict a provider screen.

At this point it should be noted that exemplary systems in accordance with the present disclosure as described above typically involve the processing of input data and the generation of output data to some extent. This input data processing and output data generation may be implemented in hardware and/or software. For example, specific electronic components may be employed in a personal computer, server, or similar or related circuitry for implementing the functions associated with automatically and/or electronically processing a health-related transaction in accordance with the present disclosure as described above. Alternatively, one or more processors operating in accordance with stored instructions may implement the functions associated with automatically and/or electronically processing a health-related transaction in accordance with the present disclosure as described above. If such is the case, it is within the scope of the present disclosure that such instructions may be stored on one or more processor readable carriers (for example, a magnetic disk), or transmitted to one or more processors via one or more signals.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. For example, although embodiments of the present disclosure described herein are related to the storage and/or the secure access to health- and heath insurance-related information, other exemplary embodiments may provide secure access to any type of information. Accordingly, other exemplary embodiments may provide secure access to, for example, transportation security information, passport information, and/or any other like type of information that may warrant multiple layers of transparent and/or secure authentication of the person/entity attempting to access such information.

Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A system, comprising:
a data store to store information associated with a person, the information including an identification information;
an input to receive the identification information and other information;
a processor coupled to the input and the data store to process an insurance transaction using the identification information and the other information; and
an output coupled to the processor and the data store to output information associated with the processed insurance claim.

2. The system according to claim 1, wherein the other information comprises information associated with medical services provided to the person.

3. The system according to claim 1, wherein the identification information is associated with one of a radio-frequency identification (RFID) tag, an identifier associated with the person, identification information stored on a magnetic strip, or biometric information.

4. The system according to claim 1, the input to receive a Media Access Control (MAC) address associated with a Point of Sale (PoS).

5. The system according to claim 4, the processor to authenticate an identity of the person using at least one of the identification information and the MAC address.

6. The system according to claim 1, wherein the information associated with the processed insurance claim comprises payment information.

7. A method, comprising:
receiving identification information and other information;
retrieving at least one of personal information or insurance information using the identification;
processing an insurance claim using the at least one of personal information or insurance information; and
outputting information associated with a processed insurance claim.

8. The method according to claim 7, wherein the other information comprises information associated with medical services provided to a person.

9. The method according to claim 7, wherein the identification information is associated with one of a radio-frequency identification (RFID) tag, an identifier associated with the person, identification information stored on a magnetic strip, or biometric information.

10. The method according to claim 7, further comprising:
receiving a Media Access Control (MAC) address of a Point of Sale (PoS) device; and
authenticating an identity of a person using at least one of the MAC address or the identification information.

11. The method according to claim 7, wherein the information associated with the processed insurance claim comprises payment information.

12. A method, comprising:
receiving-identification information associated with a person;
receiving identification information associated with a Point of Sale (PoS) device; and
providing access to information based on the identification information associated with a person and identification information associated with a Point of Sale (PoS) device.

13. The method according to claim 12, wherein the identification information associated with the person comprises one of a radio-frequency identification (RFID) tag, an identifier associated with the person, identification information stored on a magnetic strip, or biometric information.

14. The method according to claim 12, wherein the identification information associated with the PoS device comprises a Media Access Control (MAC) address of the PoS device.

15. The method according to claim 11, further comprising:
retrieving stored biometric information associated with the person based on the identification information associated with a person and identification information associated with a Point of Sale (PoS) device;
receiving input biometric information; and
comparing the stored biometric information with the input information.

16. The method according to claim 12, further comprising:
receiving information associated with a PoS administrator.

17. The method according to claim 12, wherein the information is associated with an insurance claim.

18. The method according to claim 12, wherein the information associated with a Point of Sale (PoS) device includes information associated with a location of the PoS device

19. A system, comprising:
a data store to store identification information associated with a person and identification information associated with a Point of Sale (PoS) device;
an input to receive information from a PoS device; and
a processor coupled to the input and the data store to authenticate the identity of a person using the stored identification information associated with a person and the stored identification information associated with a PoS device.

20. A computer-accessible medium encoded with computer program code effective to perform the following:
receive identification information and other information;
retrieve at least one of personal information or insurance information using the identification;
process an insurance claim using the at least one of personal information or insurance information; and
output information associated with a processed insurance claim.

21. A computer-accessible medium encoded with computer program code effective to perform the following:
receive identification information associated with a person;
receive identification information associated with a Point of Sale (PoS) device; and
provide access to information based on the identification information associated with a person and identification information associated with a Point of Sale (PoS) device.
